(19) United States
(12) Patent Application Publication
(10) Pub. No.: US 2026/0032303 A1
(43) Pub. Date: Jan. 29, 2026

(54) SYSTEMS AND METHODS FOR INTRINSIC TAGGING OF MULTIMEDIA CONTENT

(71) Applicant: VIDANGEL ENTERTAINMENT, INC., Lehi, UT (US)

(72) Inventors: Ian HUNTER, Lehi, UT (US); Jarom MCDONALD, Lehi, UT (US); Jason BODILY, Lehi, UT (US)

(21) Appl. No.: 19/282,890

(22) Filed: Jul. 28, 2025

Related U.S. Application Data
(60) Provisional application No. 63/676,784, filed on Jul. 29, 2024.

(51) Int. Cl. H04N 21/266; H04N 21/234; H04N 21/239

(52) U.S. Cl. CPC H04N 21/26603; H04N 21/23418; H04N 21/2393

(57) ABSTRACT

Disclosed embodiments relate to a method implemented by computing systems for generating a set of media-file-specific fingerprints for filtering out targeted content in a media file. Systems access a media file and generate a data representation of the media file that represents intrinsic attributes of the media file. Next, systems identify one or more data structures of targeted content in the data representation. After identifying the different data structures comprising targeted content, systems generate a set of fingerprints of the one or more data structures. Systems are configured to receive a request to stream the media file and generate a plurality of segments of the media file to be transmitted to a media player for sequential playback. Systems then compare each segment of the plurality of segments against the set of fingerprints and refrain from transmitting the particular segment to the media player.

### CROSS-REFERENCE TO RELATED APPLICATION

This application claims the benefit and priority of U.S. Provisional Patent Application Ser. No. 63/676,784, filed on 29 Jul. 2024, entitled “SYSTEMS AND METHODS FOR INTRINSIC TAGGING OF MULTI-MEDIA CONTENT,” and which application is expressly incorporated herein by reference in its entirety.

### BACKGROUND

In some media applications, users, content creators, and streaming platforms may wish to identify and tag certain portions of media content to facilitate various different functionality associated with the media. For instance, the tags can be used my media players to facilitate trick play functionality, such as enabling a user to seek and scroll through the tagged media content and to facilitate other customized playback experiences, including filtering, based on the tagged content.

To correlate the tags for content to be filtered within a streaming media file, some systems have utilized timestamps to specify the beginning and ending of the content being tagged and to synchronize the positioning of filters for the tagged content within the media file. While this method is convenient when the exact duration and content of a presentation can be assured, it poses a problem for some streaming services that experience slight variations in the transmission and rendering of the media during playback, which can desynchronize some of the tags from their correlating locations with the media.

Reasons for differing presentation compositions and playback experiences (including durations and runtimes of a media file) can include, for example, differentiation in video frame rate, pre-rolls, scene cuts (commonly to accommodate ads), or even episodic variance in how the streaming platforms split up the episodes and seasons of long duration media presentations. These variances can cause differences not only in the comprehensive viewing experience, but a wide variance in the duration of select portions of the content. These variances can notably affect the synchronization of corresponding tagged content that may be based on an initial beginning timestamp for the different media presentations.

This can significantly affect downstream processing that relies on the timestamps for providing the aforementioned playback functionality such as filtering of content, scrolling/seeking to particular tagged content, and other customized playback and enhanced information experiences.

Accordingly, there is an ongoing need and desire for improved methods and systems for identifying and correlating media content with tags and/or other identifiers that can be used to facilitate customized playback experiences of the media content, including seeking for and filtering desired content and which may address limitations associated with conventional content tagging systems.

### SUMMARY

Disclosed embodiments include systems and methods for identifying targeted content and intrinsically tagging media content for downstream filtered playback using media-file-specific fingerprints and/or global fingerprints. Some disclosed embodiments are also directed to systems and methods that utilize machine learning to facilitate the targeted content identification and tagging process.

In some aspects, disclosed embodiments relate to a method implemented by computing systems for generating a set of media-file-specific fingerprints for filtering out targeted content in a media file. For example, systems access a media file and generate a data representation of the media file that represents intrinsic attributes of the media file. Next, systems identify one or more data structures of targeted content in the data representation. Each data structure is associated with a unique set of intrinsic attributes. After identifying the different data structures comprising targeted content, systems generate a set of fingerprints of the one or more data structures. In this manner, each fingerprint corresponds to a particular data structure of the targeted content based on the unique set of intrinsic attributes for the particular data structure.

Additionally, systems are configured to receive a request to stream the media file. In response to receiving the request to stream the media file, the systems generate a plurality of segments of the media file, or portions of the segments, to be transmitted to a media player for sequential playback. Systems then compare each segment of the plurality of segments, or portions of the segment(s), against the set of fingerprints. Upon determining that a particular segment or portion of a segment matches one or more fingerprints included in the set of fingerprints, systems refrain from transmitting the particular segment or portion(s) of the segment matching the one or more fingerprints to the media player. In this manner, the sequential playback of the plurality of segments does not comprise any targeted content, thereby improving the user experience during the playback of the media file.

In some aspects, disclosed embodiments are related to a method for generating a set of global fingerprints that can be used to filter out targeted content in different media files. For example, in such embodiments, systems access a plurality of media files comprising audio-visual data and generate a plurality of data representations corresponding to the plurality of media files. Each data representation corresponds to a different media file of the plurality of media files and represents intrinsic attributes of audio-visual data included in the plurality of media files. Next, systems identify a set of data structures of targeted content within the plurality of data representations. In some instances, the data structures include context information related to the targeted content, which may include intrinsic attributes of the audio-visual data preceding and following the targeted content by a predetermined duration.

After identifying the set of data structures, systems generate a plurality of data structure subsets by clustering similar data structures together into different data structure subsets. Once similar data structures are clustered together, systems generate a set of global fingerprints. Each global fingerprint represents a different data structure subset such that a global fingerprint can be used to identify specific target content in a variety of media files.

At some time, systems access a new media file not previously included in the plurality of media files and use the set of global fingerprints to identify targeted content in the new media file. Finally, based on identifying the targeted content in the new media file using the set of global fingerprints, systems can refrain from displaying the identified targeted content on a user display, thereby improving the user experience with the media player.

In some aspects, disclosed embodiments relate to a method for training a machine learning model to perform improved identification and filtering of targeted content in multimedia files. In such embodiments, systems access a set of global fingerprints. Each global fingerprint represents a certain set of intrinsic attributes associated with different portions of targeted content identified across a plurality of different media files. The global fingerprints are then used as training data to train a machine-learning model on the set of global fingerprints. This training causes the machine learning model to learn to identify the different portions of targeted content in multimedia files. Subsequently, systems are configured to use the trained machine learning model to identify targeted content in a new media file.

This Summary is provided to introduce a selection of concepts that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of the subject matter briefly described above will be rendered by reference to specific embodiments that are illustrated in the appended drawings. Understanding that these drawings depict only typical embodiments and are not, therefore, to be limiting in scope, embodiments will be described and explained with additional specificity and detail through the use of the accompanying drawings in which:

FIG. 1 illustrates an example of time-based tagged media files obtained from different sources.

FIGS. 2A-2D illustrate an example of customizing a streaming experience based on manual or time-based tags in the media content.

FIG. 3 illustrates a flowchart of a method comprising a plurality of acts for generating a set of fingerprints for filtering out targeted content in a media file.

FIGS. 4A-4B illustrate various example embodiments of a process flowchart for generating a set of fingerprints for a media file using audio waveform data.

FIG. 5 illustrates an example embodiment of a process flowchart for generating a set of fingerprints for a media file using spectrogram data.

FIG. 6 illustrates an example embodiment of a process flowchart for generating a set of fingerprints for a media file using image data.

FIG. 7 illustrates an example embodiment of a process flowchart for generating a set of fingerprints for a media file using video data.

FIGS. 8A-8B illustrate an example embodiment of a process flowchart for using a set of media file fingerprints to identify targeted content and refrain from streaming any segments or portion(s) of any segment containing the identified targeted content.

FIG. 9A illustrates a flowchart of a method for generating a set of global fingerprints.

FIG. 9B illustrates an example embodiment of a process flowchart for generating a global fingerprint index.

FIG. 9C illustrates an example embodiment of a global fingerprint index.

FIG. 9D illustrates an example embodiment of a process flowchart for generating a global fingerprint.

FIG. 9E illustrates another example embodiment of a process flowchart for generating a global fingerprint.

FIG. 10 illustrates an example embodiment of a process flowchart for utilizing a global fingerprint index to provide a customized streaming experience of a media file.

FIG. 11 illustrates a flowchart of a method comprising a plurality of acts for training a machine learning model to perform improved identification and filtering of targeted content.

FIG. 12A illustrates an example embodiment of a process flowchart for training a machine learning model on a global fingerprint index.

FIG. 12B illustrates an example embodiment of a process flowchart for implementing a machine learning model previously trained on a global fingerprint index.

FIG. 13 illustrates an example computing environment in which a computing system incorporates and/or is utilized to perform disclosed aspects of the disclosed embodiments.

### DETAILED DESCRIPTION

Disclosed embodiments include systems and methods that may be utilized to improve the identification, tagging, and filtering process for targeted content in media files using intrinsic attribute tags or fingerprints. For example, in some embodiments, systems and methods are provided for generating and using media-file-specific fingerprints to identify and filter targeted content in a particular media file. Additionally, or alternatively, some systems and methods are provided for generating and using global fingerprints to identify and filter targeted content in different media files. Some embodiments are also directed to systems and methods that utilize a machine learning model trained on global fingerprints to facilitate an efficient and accurate identification, tagging, and filtering process.

The disclosed embodiments beneficially provided many technical benefits over existing timestamp-based tagging systems. For example, in contrast to conventional tagging systems dependent upon time synchronization, the disclosed embodiments are not limited to time synchronization to enable their functionality. Instead, the disclosed embodiments identifying portions of content using intrinsic attributes of audio, visual, or audiovisual content allows for applications to make decisions concerning that presentation regardless of the mediums by which the content is made available and which enables the customized playback and filtering functionality that was heretofore dependent upon time synchronizing tags. For the purpose of filtering, a server-side device may be tasked with identifying select portions of a presentation to be filtered by monitoring the attributes (audio, visual, audiovisual) of the media content before and/or during runtime (e.g., streaming of the media).

During streaming of playback of a media presentation, a set of persisted fingerprints of data that represent previously identified portions of the presentation can be compared in real-time to the playback experience, whereby objectionable content can be identified and acted upon. It is anticipated that the resources required will be optimized for the real-time computation and analysis of portions of media presentations.

In some embodiments, additional metadata is accessed to allow the server that is controlling the playback experience to know which segments or portions of a segment of media more precisely may contain previously identified intrinsic portions of media. At its most basic, metadata might include intrinsic attributes used to identify the instance of entertainment (i.e., the movie by title). More granularly, another example of additional metadata that could be used is a beginning timestamp of targeted content. Another example of additional metadata could be a list of affected segments or segment portions or an ordering of the portions to be identified. In this way, instead of all portions of a video presentation needing to be monitored for all instances of previously identified portions, only portions of a presentation need be monitored for previously identified portions.

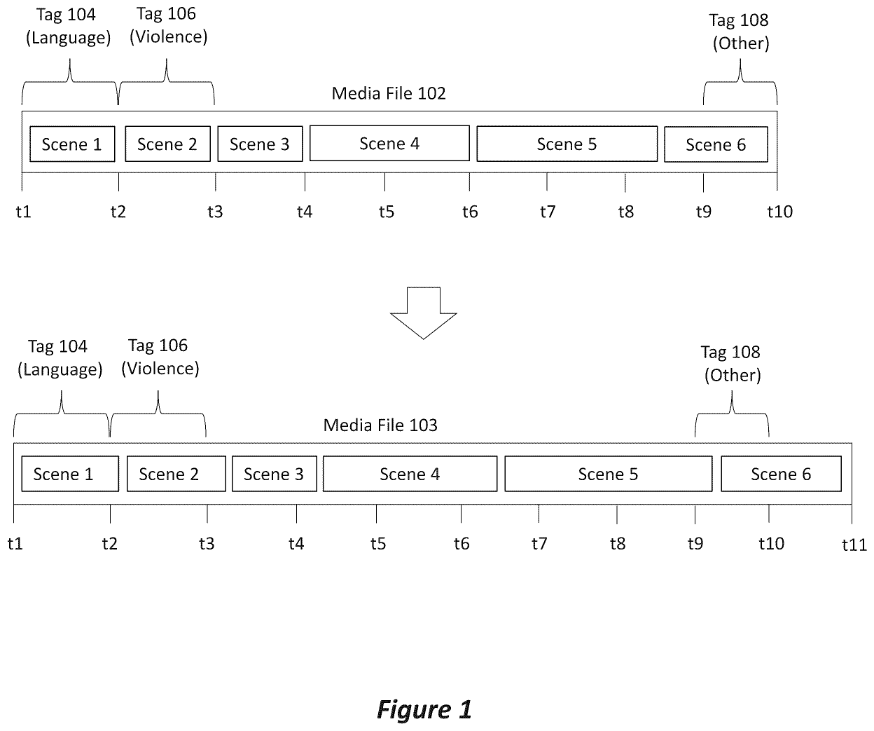

The disclosed embodiments may be utilized to realize many of these technical benefits and advantages, and others described in more detail throughout, over existing systems and methods that use timestamp-based tagging systems. For example, FIG. 1 illustrates an example of time-based tagged media files obtained from different sources. For example, a media file (e.g., media file 102) that has been tagged with various tags (e.g., tag 104, tag 106, tag 108) associated with different categories of targeted content (e.g., tag 104 is associated with offensive language, tag 106 is associated with violence, tag 108 is associated with other categories). In the context of filtering, the universal filters and/or user filters are employed based on identifying the portions of the media file that have tags that do not meet the filtering criteria and filtering out any frames that correspond to those portions of the media file. In this manner, undesired content is not present in the playback of the media file.

However, these tags are typically time-based or timestamp tags that correspond to specific start and stop times of the media file. For example, tag 104 is associated with Scene 1, which runs from t1 to t2; tag 106 is associated with Scene 2, which runs from t2 to t3; and tag 108 is associated with a portion of Scene 6, which runs from t9 to t10.

However, these timestamp-based tags cannot always be used universally for the same media content obtained from different sources. This is because sometimes the same media content (i.e., the same television show episode or movie) may have different runtimes based on various factors, including different frame rates and adaptations for different platforms (e.g., television channel vs. online streaming), among other factors. Thus, if the system were to apply the original tags to a media file comprising the same or substantially the same media content but from a different source, the tags may not correspond to the correct locations in the media file.

For example, as shown in FIG. 1, tag 104 applied to media file 103 (representing media content substantially similar to media file 102 but obtained from a different streaming platform) covers t1 to t2, but does not cover the final portion of Scene 1, as it does for media file 102. Similarly, tag 106 begins too early at t2, now starting at the end of Scene 1 and not covering the entire portion of Scene 2, as it did for media file 102. Additionally, while the beginning tags may only be off by a little bit, the mismatch compounds as the temporal location in the media file increases, as can be seen by tag 108 in media file 103, which, instead of covering an ending portion of Scene 6 in media file 102, now covers the end of Scene 5 and beginning of Scene 6 in media file 103.

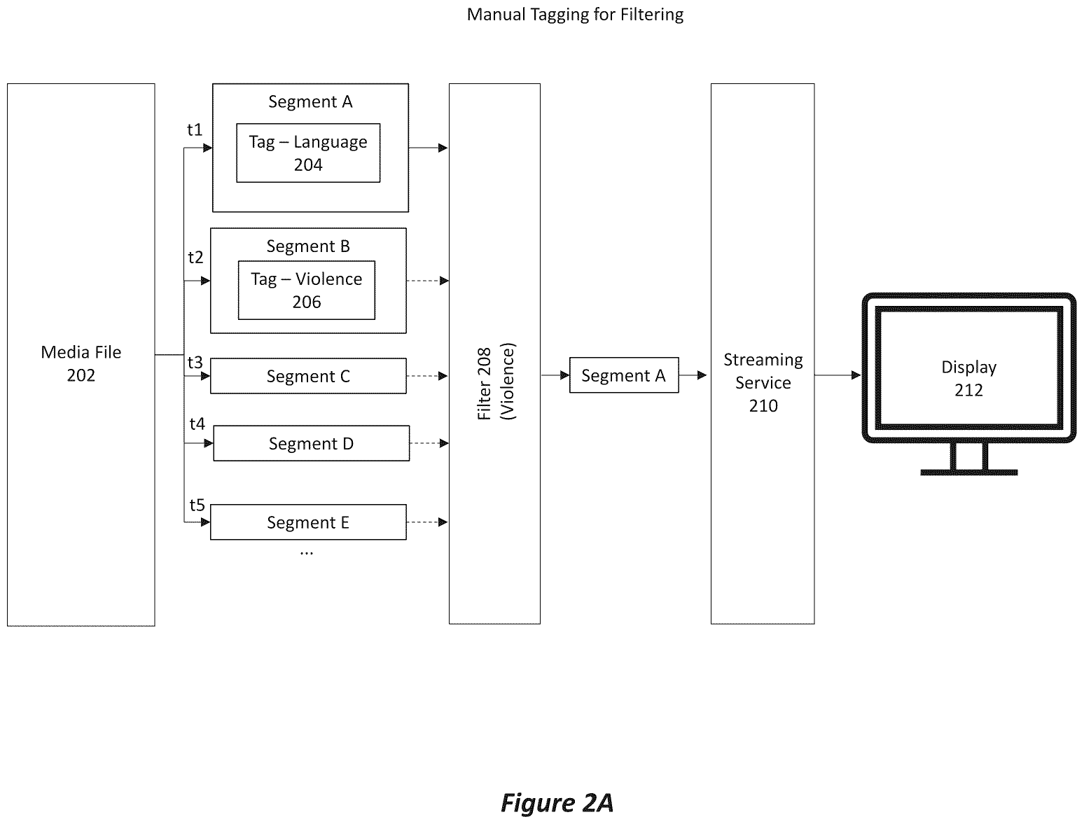

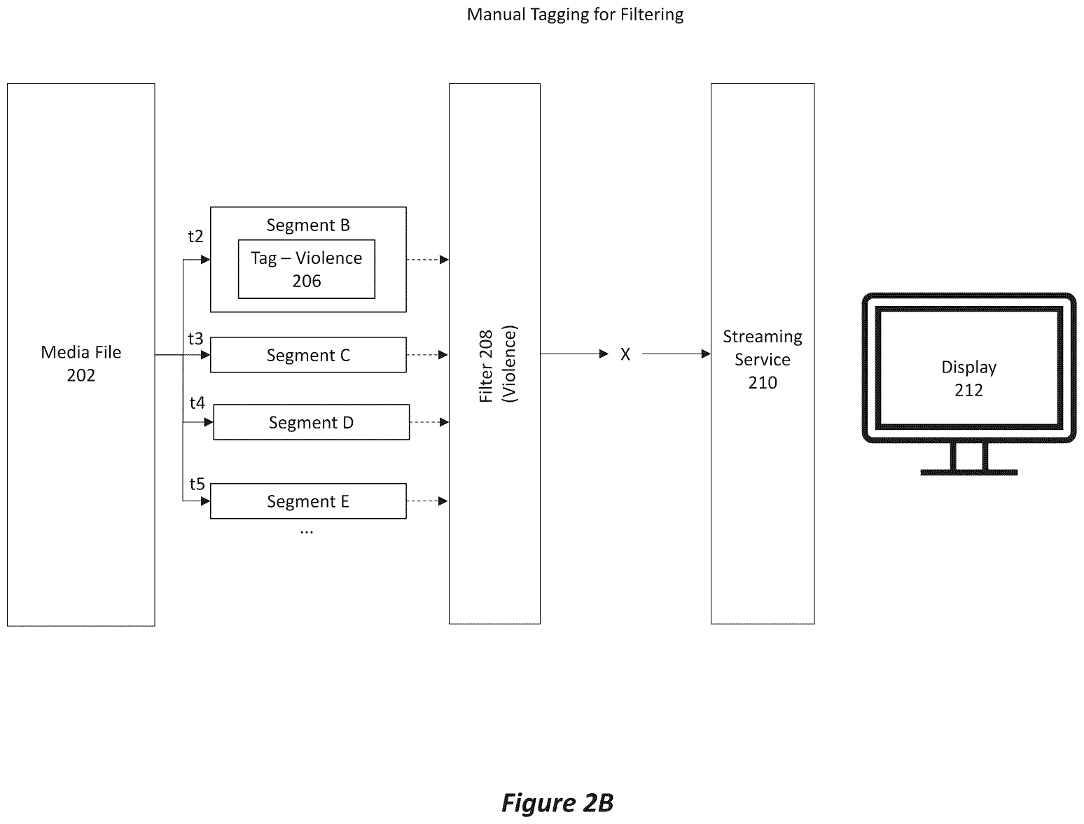

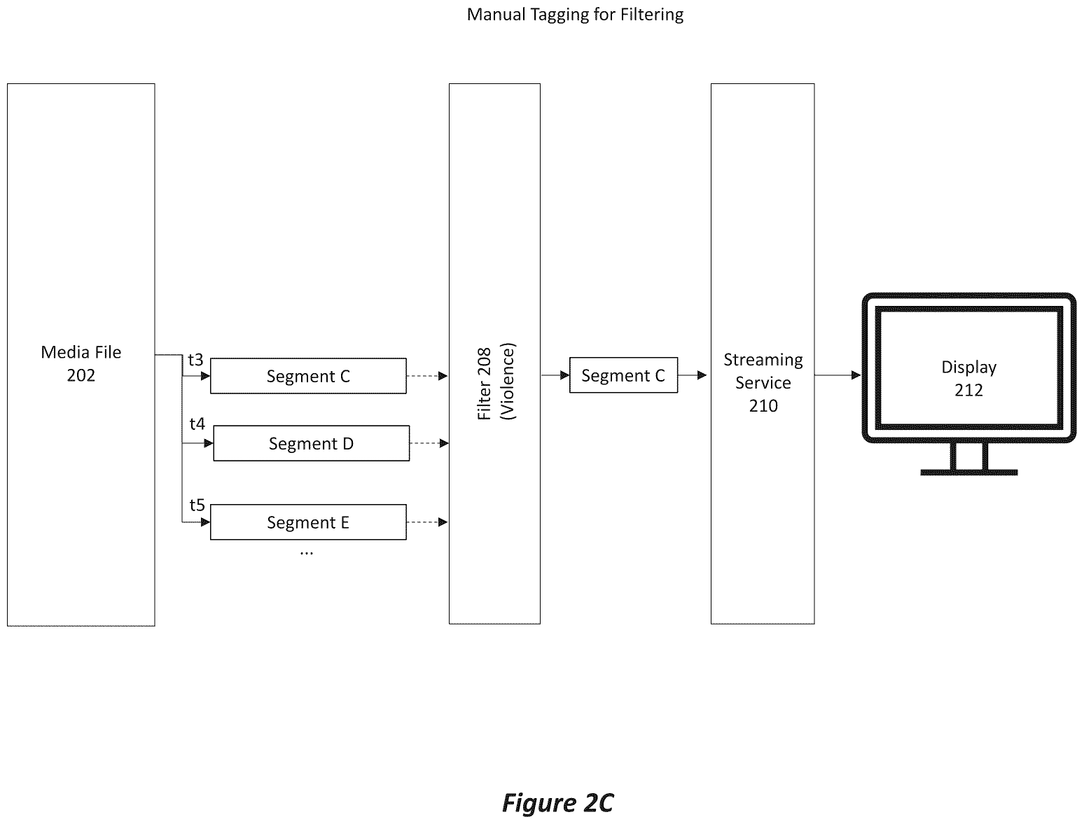

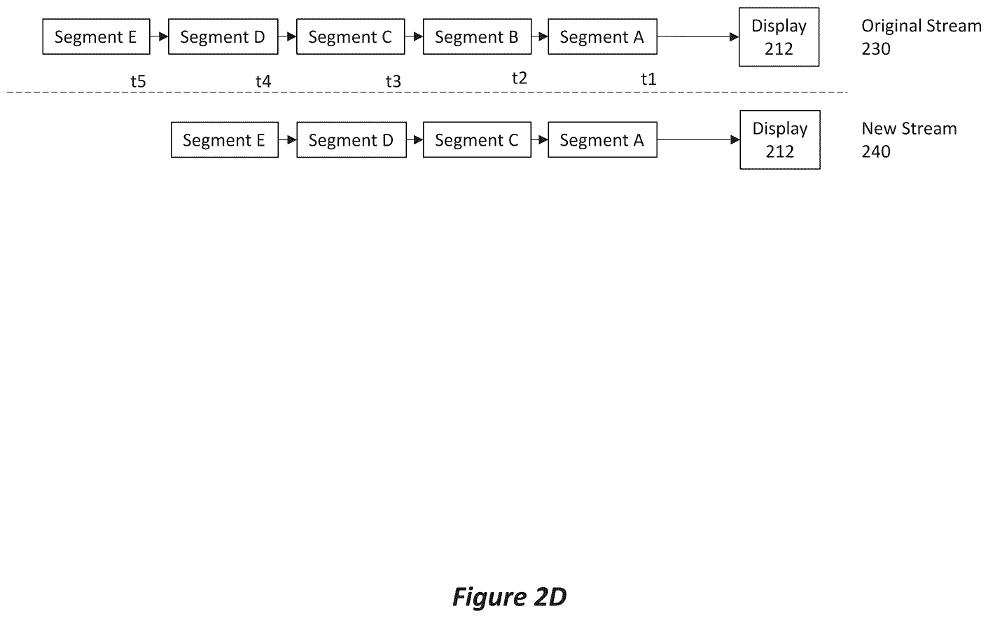

Attention will now be directed to FIGS. 2A-2D, which illustrate an example of customizing a streaming experience based on manual or time-based tags in the media content. For example, FIG. 2A illustrates a media file (e.g., media file 202). Media file 102 is divided into a plurality of segments (e.g., Segment A, Segment B, Segment C, Segment D, Segment E, and so on . . . ). Some segments have corresponding time-based tags (e.g., Segment A has Tag 204 (language), and Segment B has Tag 206 (violence).

In this case, the system has received input that configured the system to filter out any segments that contained a tag for violence (e.g., Filter 208 (Violence)). Segment A passes through Filter 208. Even though it has a tag, its tag is for language, and is not filtered out by Filter 208, which is configured to filter out any segments with the tag for violence. Thus, Segment A is transmitted to the streaming service 210, which plays back the segment on the user's device (e.g., display 212). Next, Segment B is passed to Filter 208; however, because Segment B does have a tag for violence (e.g., tag 206), the system refrains (see: “x”) from transmitting the segment to the streaming service.

Segment C meets the criteria set by Filter 208 because it does not have any tags (therefore has no violence tags) and is subsequently transmitted to the streaming service 210. In this manner, the system will pass each segment sequentially to the filter to determine whether to refrain from transmitting or to transmit the segment to the streaming service/user device until all segments from the media file are processed.

Attention will now be directed to FIG. 2D, which illustrates an original playback experience of a media file versus a customized playback experience of the same media file. For example, original stream 230 shows the media file segments (e.g., Segment A, Segment B, Segment C, Segment D, and Segment E) of the media file 202 being played back sequentially on display 212. In contrast, new stream 240, which represents a customized playback experience, shows only Segment A, Segment C, Segment D, and Segment E being passed to the media player for playback, wherein Segment B was filtered out (see, FIG. 2B).

With regard to the foregoing example, it is noted that the reference to different segments (i.e., Segment A, Segment B, Segment C, Segment D, Segment E, and so on . . . ) can also be interpreted as discrete sub-portions of a single larger media segment that is partitioned from a media file into segments for streaming, for example.

If a system is trying to use tags from a first media file (e.g., media file 102) and apply them to a new media file (e.g., media file 103) and then refrain from streaming certain portions of the media file (as part of a playback sequence) that correspond to one or more tags, the system may end up transmitting portions of the media file that a user wanted to avoid viewing, causing a negative user experience with the media player/platform. In other instances, if the system is trying to utilize the tags to provide an enhanced media experience for the user by providing additional information about actors, product placements, and/or external links to such items, the tags will not match up to the right frames in the media file while they are playing back on the user device.

Thus, it should be appreciated that the disclosed embodiments realize many benefits over time-based tagging systems and methods, wherein the novel systems and methods described herein relate to intrinsic attribute-based tagging systems that are able to be used on many different media files, no matter the source. Additionally, these intrinsic attribute tags are configurable and can be increased in scope to different media files comprising different media content across multiple sources and platforms. In other words, while time-based tags are limited to use for a particular movie (and suffer degradation in utility/accuracy for identifying targeted content in the same movie but obtained from/played back through a different source), these intrinsic attribute tags are applicable to the same movie across all platforms/sources without incurring a decrease in accuracy for identifying/filtering targeted content. Additionally, these intrinsic attribute tags are also applicable globally to different movies, television shows, podcasts, or other media content.

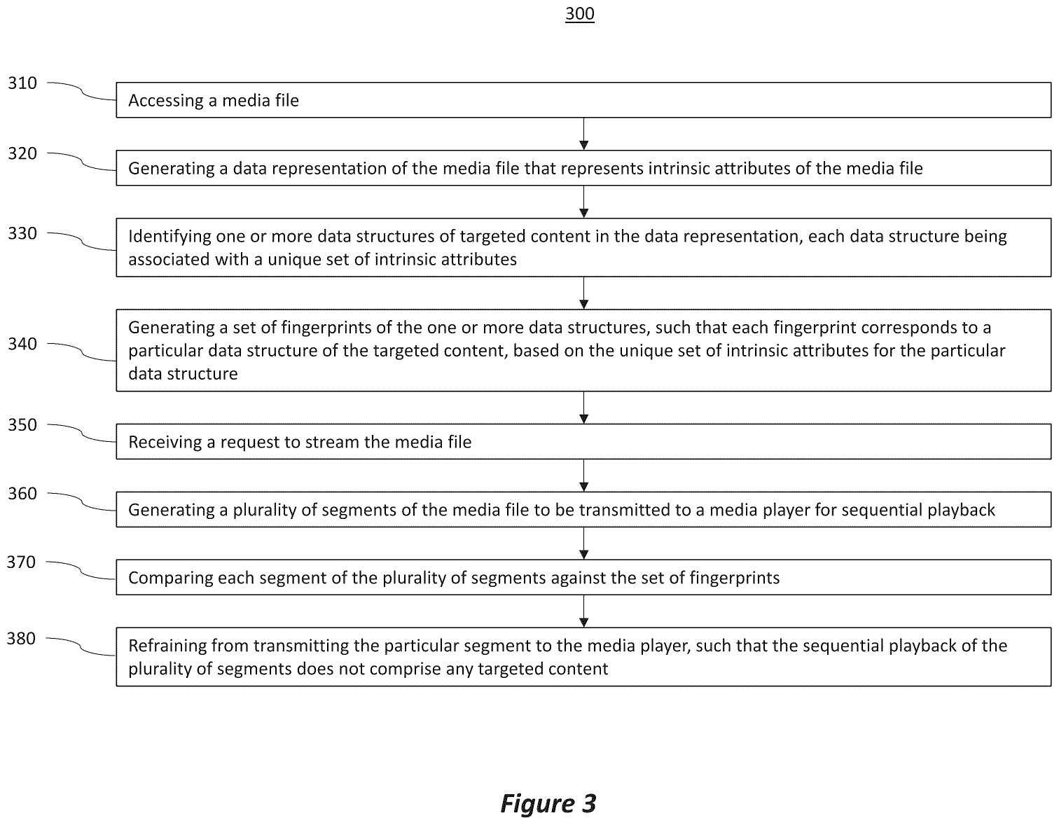

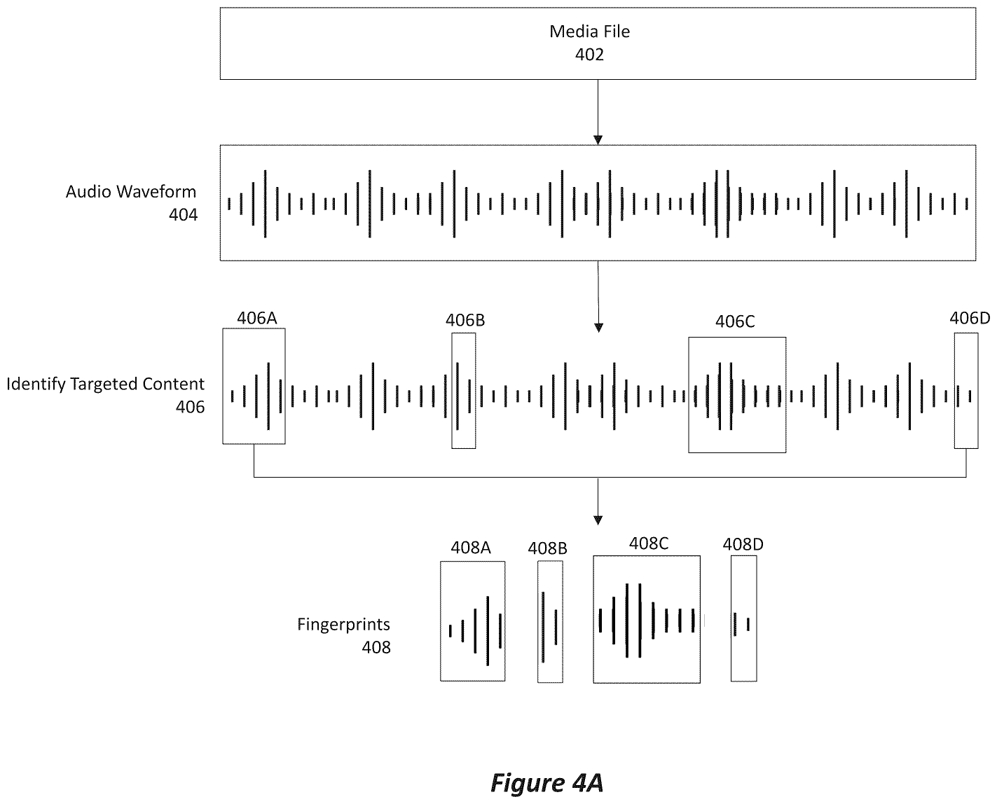

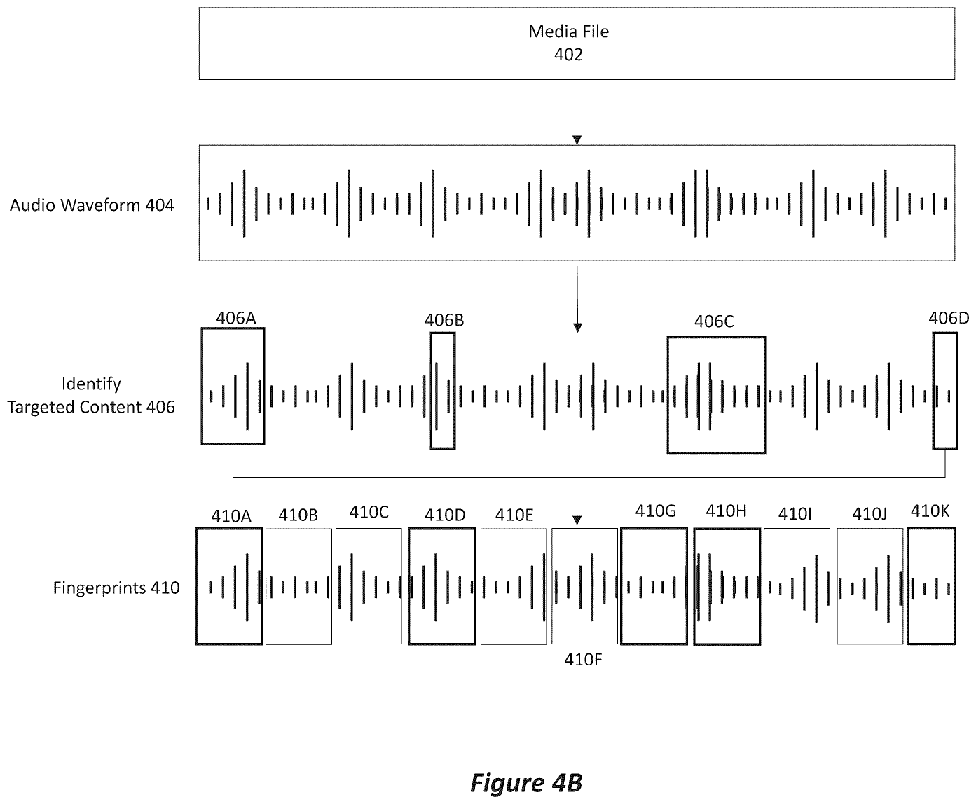

Attention will now be directed to FIG. 3, which illustrates a flowchart of acts (act 310, act 320, act 330, act 340, act 350, act 360, act 370, and act 380) associated with method 300 that can be implemented by a computing system (e.g., computing system 1300) and is configured for generating a set of fingerprints for filtering out targeted content in a media file. It should be appreciated that FIG. 3 will be described with reference to components and processes illustrated throughout FIGS. 4A-4B, 5-7, 8A-8B.

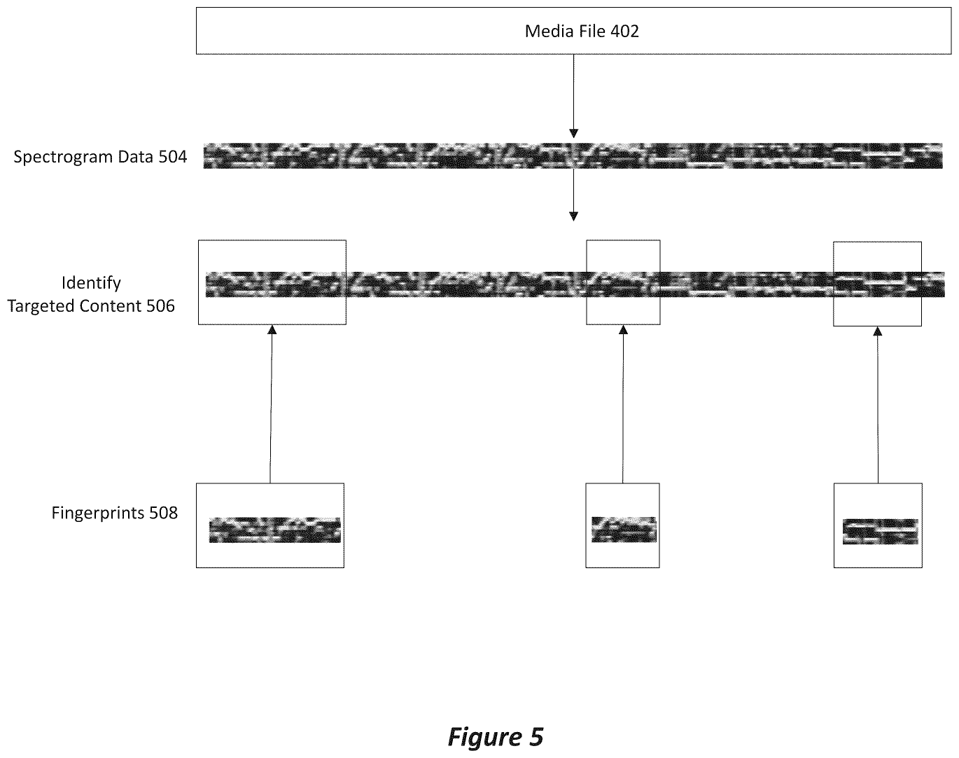

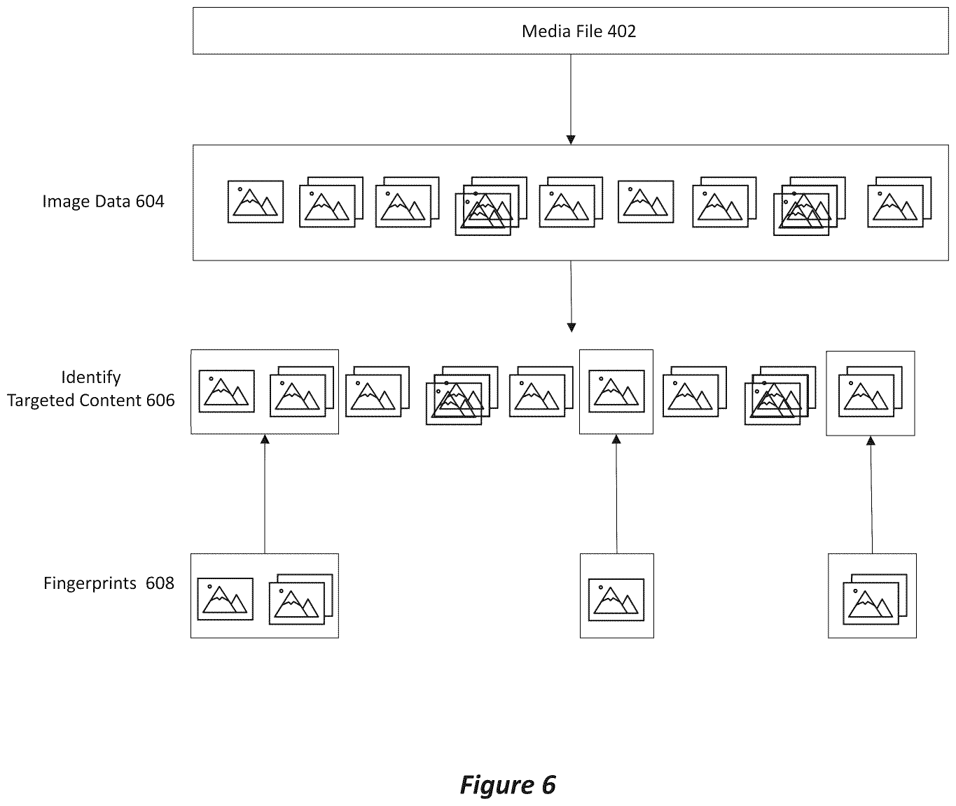

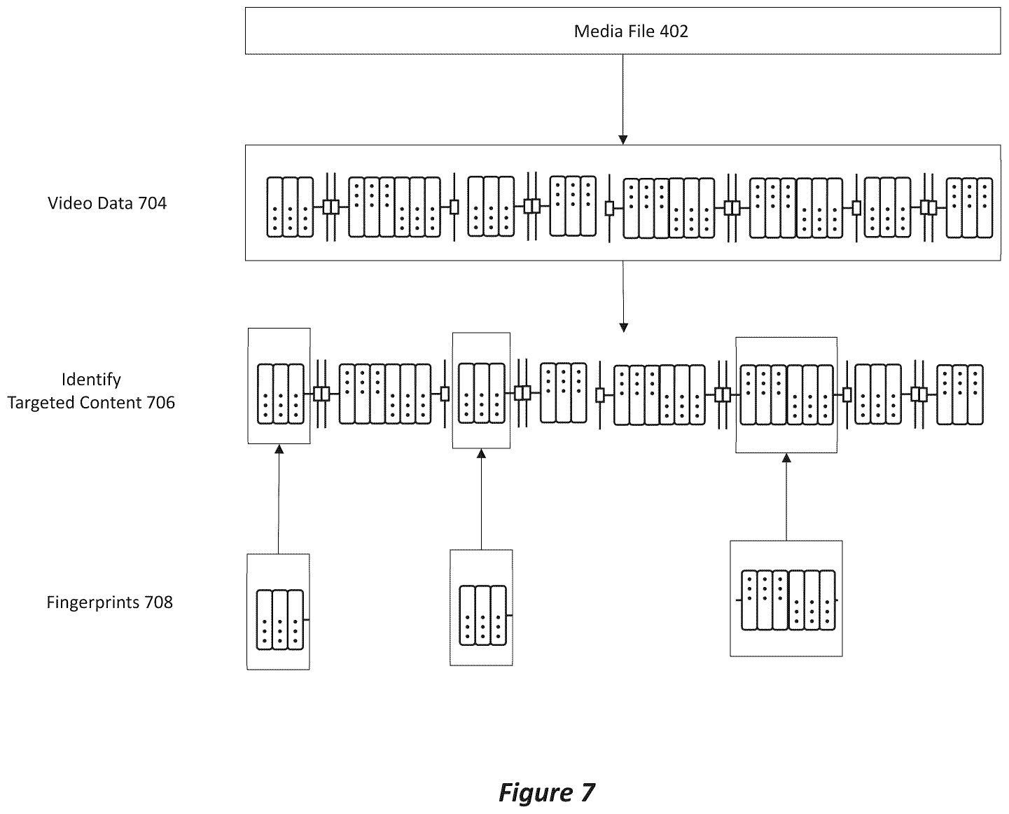

A first illustrated act is provided for accessing a media file (e.g., media file 402) (act 310) and generating a data representation of the media file that represents intrinsic attributes of the media file (act 320). As shown in FIGS. 4A-4B, the data representation may be derived from audio, video, or a combination of audio and video data, including, but not limited to audio waveforms, spectrograms, and image analysis data. By way of example, the data representation may comprise audio waveform 404. As shown in FIG. 5, the data representation may comprise spectrogram data 504. As shown in FIG. 6, the data representation may comprise image data 604. As shown in FIG. 7, the data representation may comprise video data 704).

Next, systems identify one or more data structures (e.g., data structure 406A, data structure 406B, data structure 406C, and data structure 406D) of targeted content in the data representation. Each data structure is associated with a unique set of intrinsic attributes (act 330). The system can identify many diverse types and categories of targeted content. In some instances, the system can access user-defined settings, including generation criteria that will be used to determine which fingerprints are generated from the various identified targeted content of a media file.

For example, in some instances, the generation criteria are based on universal generation criteria, which will only generate fingerprints that meet the generation criteria across all pre-defined categories of targeted content. Thus, fingerprints generated based on this universal generation criteria will be suitable for all users, regardless of varying personal preferences, as it will be a set of fingerprints that can be used to retain only those media file segments that are least likely to contain any content that might be considered offensive or triggering during playback of the media file. It should be appreciated that the set of fingerprints generated based on the universal generation criteria may be generated in response to receiving a request to access a particular media file or, alternatively, may be generated before a request and stored along with the media file as part of a modified media file.

In some instances, the generation criteria are based on user-defined profile settings, which are configured to be applied to any media file that is accessed through the corresponding user profile. In some instances, the profile settings are configured as parental settings or manager/employer settings that define criteria for multiple user profiles. Additionally, or alternatively, the generation criteria are based on user-defined generation criteria that are specific to a particular media file.

In some instances, the generation criteria are based on a combination of the universal generation criteria, user-defined profile settings, and user-defined media file settings. The system is configurable to employ a priority system to determine which source of generation criteria to weigh more heavily or which source of generation criteria to use in the event of conflicting settings (e.g., the user-defined profile settings may set generation criteria of no violence, while the user-defined media file settings 806 may define generation criteria of only no gun violence—which may allow for other types of violent content to be viewed).

In some instances, the generation criteria can also consider context information associated with targeted content, such as the media content immediately preceding or following the targeted content. In this regard, the context information can be included in a fingerprint used to identify the targeted content in related media, without requiring the context information to be considered part of the targeted content that is selectively filtered from the related media.

Referring to FIG. 3 (with reference to FIG. 4A), after identifying the different data structures comprising targeted content, systems generate a set of fingerprints (e.g., fingerprints 408) of the one or more data structures (act 340). In this manner, each fingerprint corresponds to a particular data structure of the targeted content based on the unique set of intrinsic attributes for the particular data structure. For example, fingerprint 408A corresponds to targeted content 406A, fingerprint 408B corresponds to targeted content 406B, fingerprint 408C corresponds to targeted content 406C, and fingerprint 408D corresponds to targeted content 406D.

In some instances, as shown in FIG. 4B, the system generates a set of fingerprints (e.g., fingerprint 410) that includes a fingerprint for every portion of the media file (e.g., fingerprint 410A, fingerprint 410B, fingerprint 410C, fingerprint 410D, fingerprint 410E, fingerprint 410F, fingerprint 410H, fingerprint 410G, fingerprint 410H, fingerprint 410I, fingerprint 410J, and fingerprint 410K).

Additionally, systems are configured to receive a request to stream the media file (e.g., media file 402) (act 350). Several different triggering events could be used and/or identified to trigger the activation of the digital media player's trick-play mode. For example, in some instances, the triggering event includes receiving a user request to access or stream a media file using the digital media player, including identifying a user selection at a user interface associated with a digital media play. In some instances, the triggering event includes identifying a user selection at a user interface associated with the digital media player for at least one of the following actions: play, pause, fast-forward, rewind, scrub, or seek.

In response to receiving the request to stream the media file, the systems generate a plurality of segments (e.g., segment 806) of the media file to be transmitted to a media player for sequential playback (act 360). It should be appreciated that the system is able to generate segments either directly from media 402 and/or from the data representation (e.g., audio waveform 804) of the media file.

Systems then compare each segment of the plurality of segments against the set of fingerprints (act 370). For example, the system passes segment 806A to filter 808 and compares segment 806A against fingerprints 408, including fingerprint 408A, fingerprint 408B, fingerprint 408C, and fingerprint 408D. In this case, segment 806A matches fingerprint 408A, meaning that segment 806A comprises targeted content and does not meet the criteria for filter 808. And, as mentioned earlier, each segment mentioned in this regard can be an entire partitioned segment of a media file that was partitioned according to a particular media streaming scheme, for example, or only a sub portion of that segment.

In some instances, the system accesses a predetermined fingerprint match threshold, wherein a matching score is determined based on comparing the media file segment with the fingerprint. In such instances, a segment is determined to be a match of a fingerprint if it meets or exceeds the predetermined fingerprint match threshold.

To configure filter 808, the system accesses filtering criteria based on user-defined settings or system default settings. These filtering criteria are similar to/can be based on the same settings as the generation criteria described above, including media-file-specific settings, user profile settings, and/or universal settings. For example, in some instances, filtering criteria are used as part of a filter, such as filter 808 or filter 1006, to determine a subset of fingerprints (either from the media file fingerprints or from a global fingerprint index) that will be used to identify media file segments that should not be transmitted to the media player. In this manner, the system can fine-tune and customize the user playback experience by determining customized subsets of fingerprints to be used to identify targeted content and refrain from displaying it on the user's device during playback of the media file. The selective filtering can also be based on contextual information, such as the context of media preceding and following targeted content and attributes of that contextual information which may itself be represented by corresponding fingerprints.

In such embodiments, subsequent to generating the set of fingerprints, systems receive user input that defines one or more categories of targeted content and filters the set of fingerprints to include only those fingerprints that correspond to the one or more categories of targeted content, such that the sequential playback of the plurality of segments does not comprise targeted content from the one or more categories.

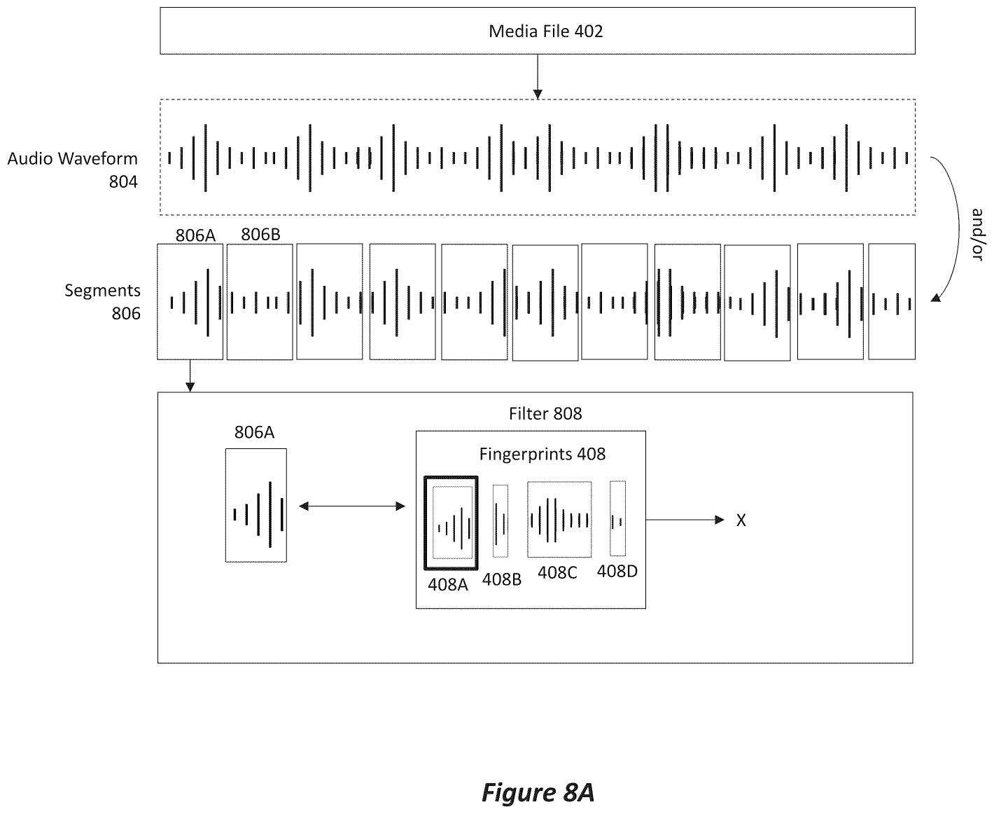

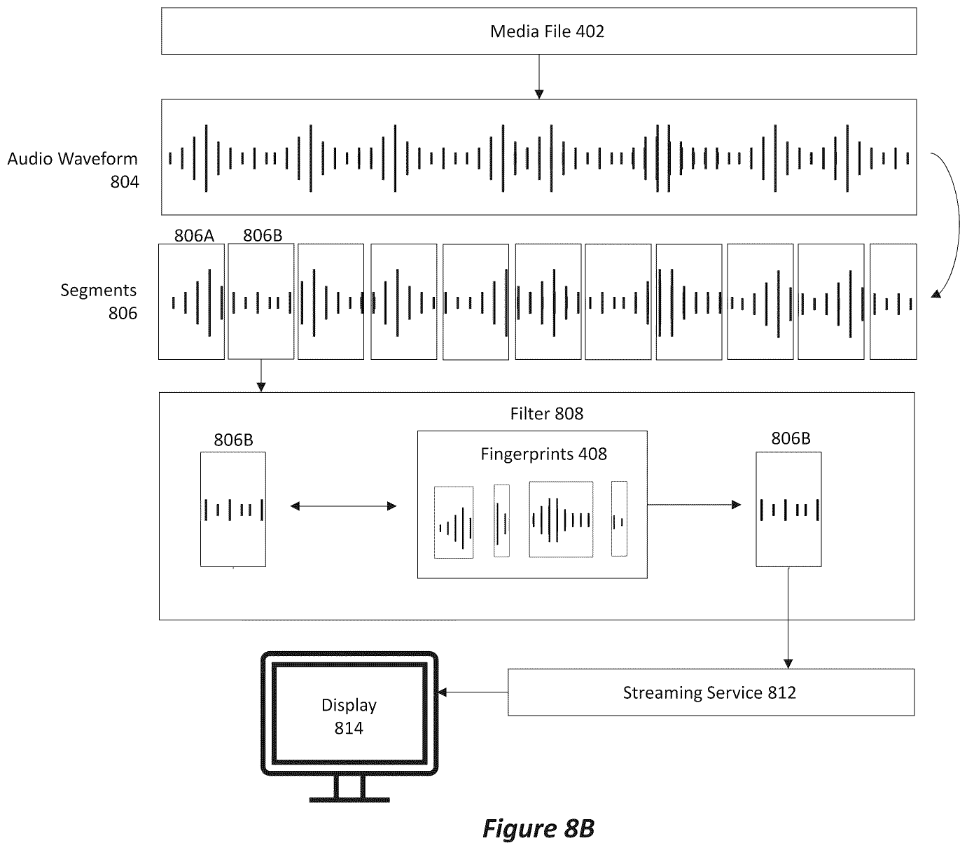

Accordingly, upon determining that a particular segment (e.g., segment 806A) matches one or more fingerprints (e.g., fingerprint 408A) included in the set of fingerprints, systems refrain from transmitting the particular segment, or portion of a segment, to the media player (see FIG. 8A, act 380). As shown in FIG. 8B, if the segment (e.g., segment 806B) does not match any fingerprints (e.g., fingerprints 408), the system does transmit the segment to a streaming service (e.g., streaming service 812) to be played back on a user's device (e.g., display 814). In this manner, the sequential playback of the plurality of segments does not comprise any targeted content, thereby improving the user experience during the playback of the media file.

Regarding the foregoing example, it will be appreciated that the system does not need to evaluate each fingerprint of offensive or targeted content against a media segment before determining to filter a segment or portion of a segment that contains targeted content. Instead, the identification or match of only a single fingerprint (or a predetermined quantity of fingerprint instances) of targeted content within a segment, or portion of a segment, is sufficient to filter that segment or portion of the segment from being transmitted and/or displayed. For instance, once a single fingerprint or a predetermined quantity of fingerprints of targeted content are identified in a segment, the system may refrain from performing any further processing of a segment for matching fingerprints of targeted content. This can help conserve processing that is not necessary to trigger the filtering of a segment or sub-portion of a segment, as the triggering event for filtering the segment or segment sub-portion can occur without evaluating whether every fingerprint of targeted content is present within each segment or even any particular segment or portion of a segment for which a matching fingerprint has already been found.

While FIGS. 4A-4B and FIGS. 8A-8B are shown using audio waveform data for the data representation of the media file, it should be appreciated that any data representation may be used to generate fingerprints. For example, FIG. 5 is shown generating a data representation comprising spectrogram data 504, wherein the system identifies targeted content 506 in the spectrogram data 504 and generates one or more fingerprints 508 corresponding to the different portions of targeted content that were identified in the spectrogram data. Similarly, in FIG. 6, media file 402 is transformed into image data 604, wherein the system identifies targeted content 606 in the image data and generates one or more fingerprints 608 based on the identified targeted content 606. As another example, FIG. 7 illustrates a media file 402 being converted/extracted into video data 704, wherein the system identifies targeted content 706 in the video data and generates one or more fingerprints 708 that correspond to the different portions of targeted content 706 identified in the video data 704.

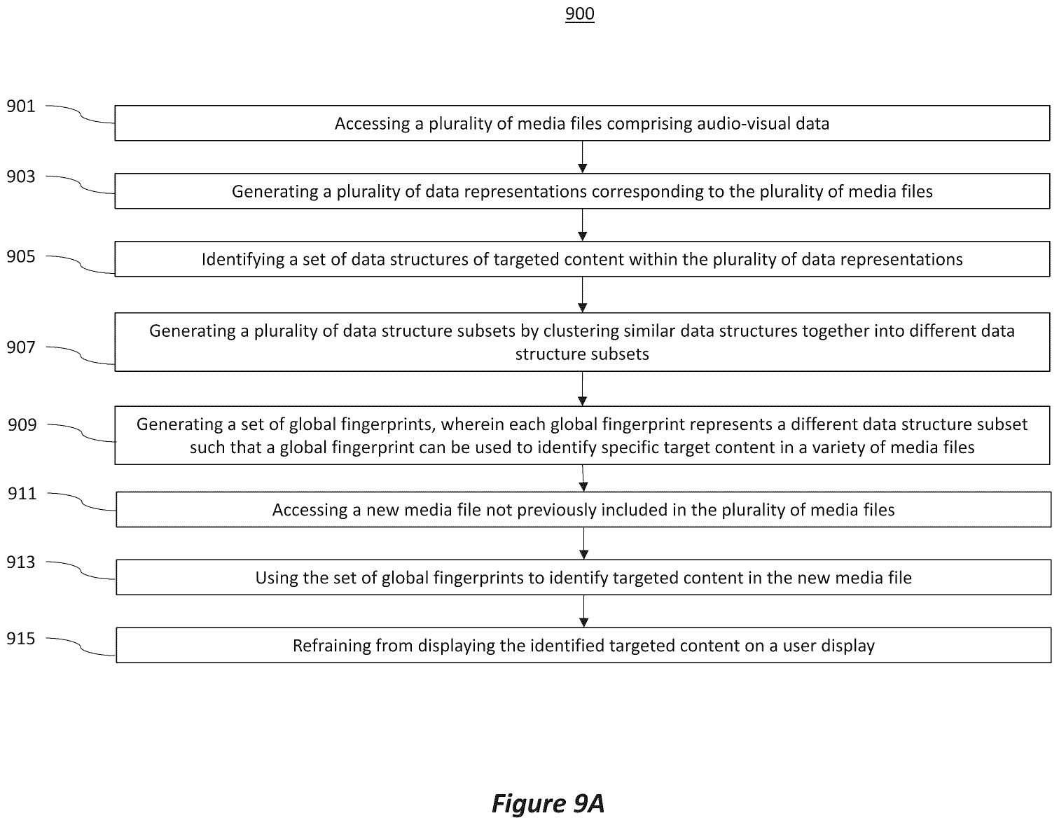

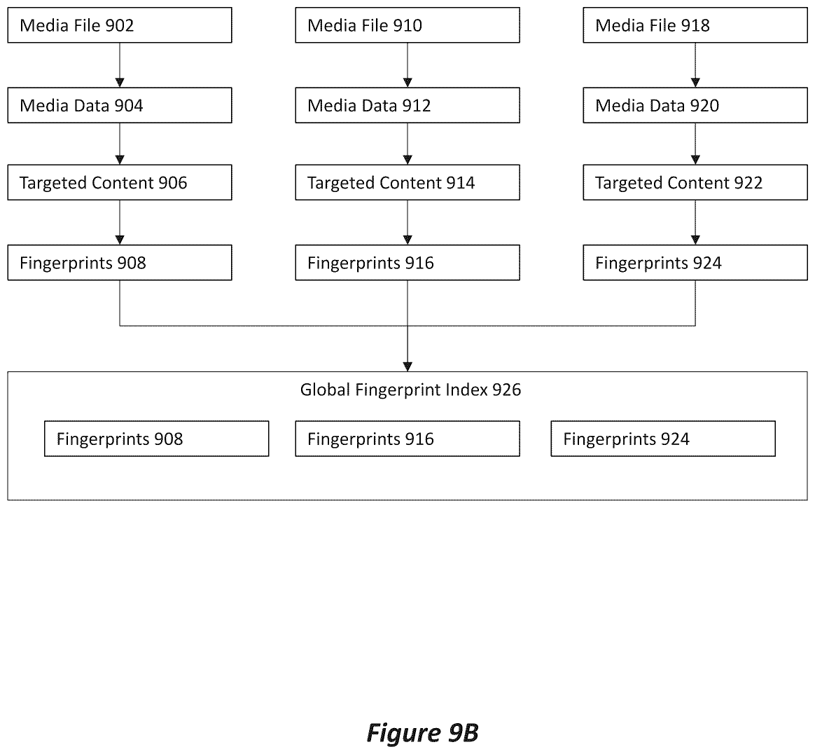

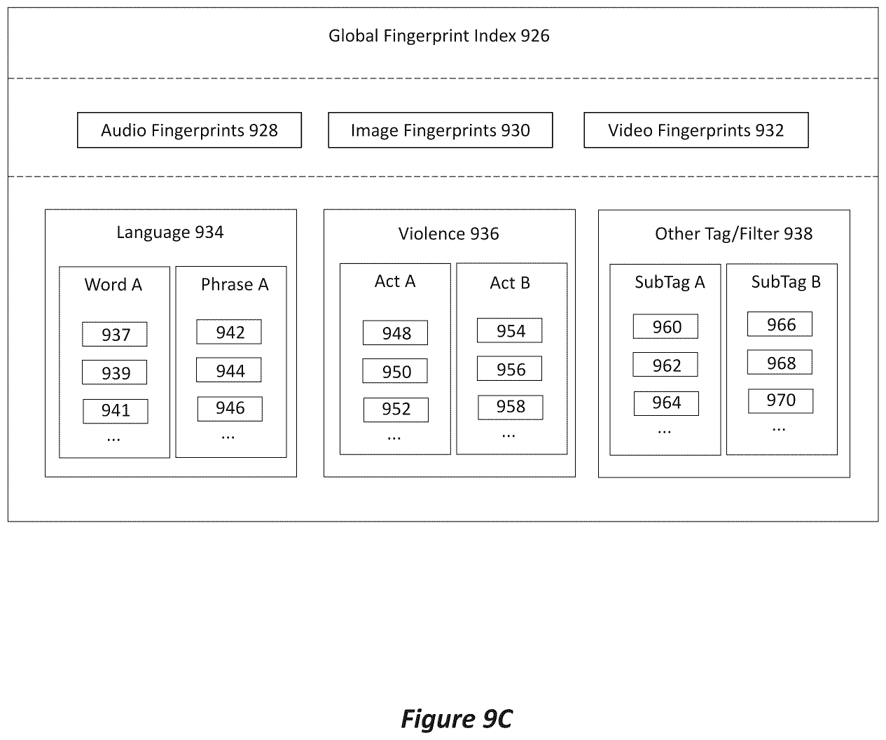

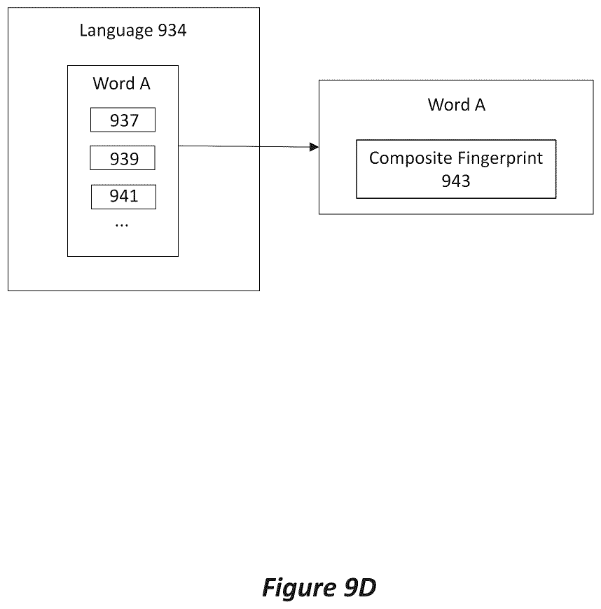

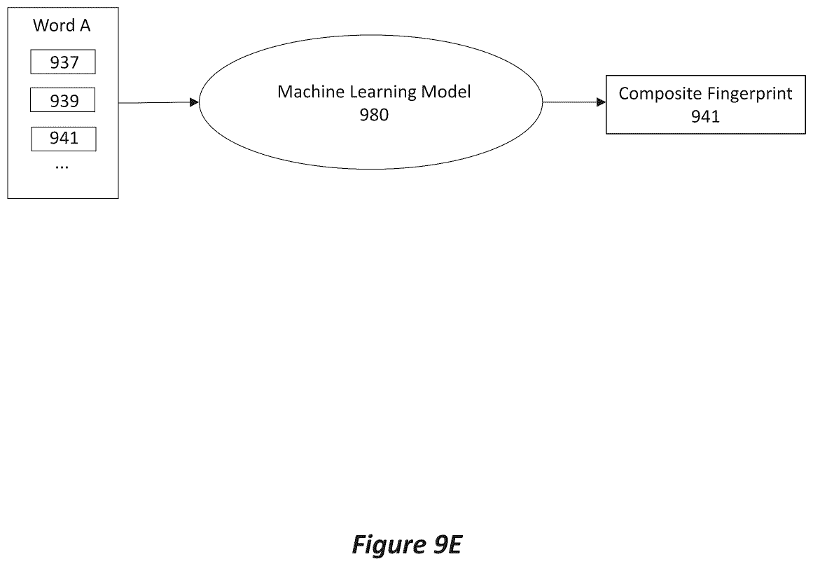

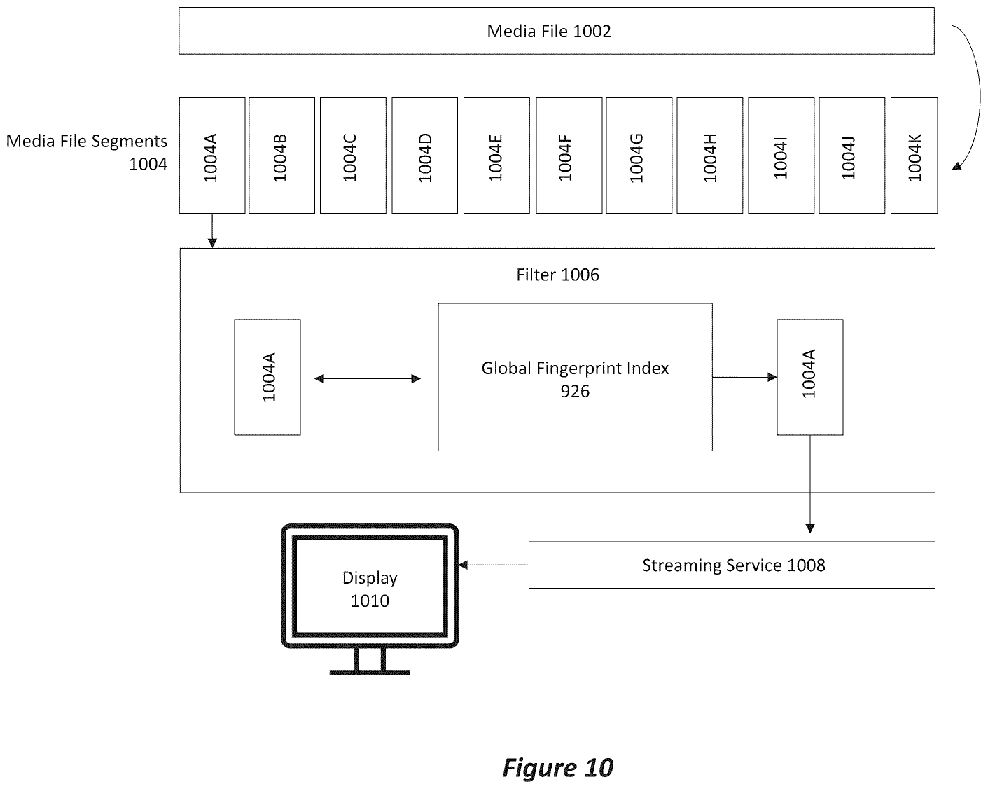

Attention will now be directed to FIG. 9A, which illustrates a flowchart of acts (act 901, act 903, act 905, act 907, act 909, act 911, act 913, and act 915) associated with method 900 that can be implemented by a computing system (e.g., computing system 1300) and is configured for generating a set of global fingerprints. Notably, the acts of FIG. 9A are further described with reference to FIG. 9B and FIG. 10.

A first illustrated act is provided for accessing a plurality of media files (e.g., media file 902, media file 910, and media file 918) comprising audio-visual data (act 901) and generating a plurality of data representations corresponding to the plurality of media files (e.g., media data 904 corresponding to media file 902, media data 912 corresponding to media file 910, and media data 920 corresponding to media file 918) (act 903). Each data representation corresponds to a different media file of the plurality of media files and represents intrinsic attributes of audio-visual data included in the plurality of media files. In some instances, the media data comprises audio waveform data, spectrogram data, image data, and/or video data.

Next, systems identify a set of data structures of targeted content (e.g., targeted content 906, targeted content 914, and targeted content 922) within the plurality of data representations (act 905). The data structure may include a combination of detected elements of the data representation of the media file. For instance, an audio file can comprise an audio waveform data representation and a segment or portion of the audio waveform may correspond to or comprise a data structure of targeted content. In such an instance, all peaks of the audio waveform within a predetermined period of the waveform may represent the data structure as a fingerprint. Alternatively, an additional or different fingerprint of the data structure may be derived from the peaks or other features of the audio waveform that correspond to the predetermined period of the waveform representing the data structure. Contextual fingerprints can also be generated for contextually relevant data to a base segment fingerprint, such as the audio and/or visual data preceding or following the specific segment or segment portion that the base fingerprint was generated for. After identifying the set of data structures, systems generate a plurality of data structure subsets by clustering similar data structures together into different data structure subsets (act 907).

Once similar data structures are clustered together, systems generate a set of global fingerprints (act 909). Each global fingerprint represents a different data structure subset such that a global fingerprint can be used to identify specific target content in a variety of media files. These global fingerprints can include or exclude the context fingerprints that can be used to help identify targeted content of the base segment fingerprints. It should be appreciated that there are different methods described herein for generating global fingerprints, as will be described in more detail below in reference to FIGS. 9B-9E.

Referring back to FIG. 9A (with reference to FIG. 10), systems access a new media file (e.g., media file 1002) not previously included in the plurality of media files (e.g., media file 902, media file 910, media file 918) (act 911) and use the set of global fingerprints (e.g., global fingerprint index 926) to identify targeted content in the new media file (act 913).

For example, as shown in FIG. 10, media file 1002 is segmented into a plurality of segments (e.g., media file segments 1004, including segment 1004A, segment 1004B, segment 1004C, segment 1004D, segment 1004E, segment 1004F, segment 1004G, segment 1004H, segment 1004I, segment 1004J, and segment 1004K). A first segment (e.g., segment 1004A is passed to filter 1006 and is compared against fingerprints included in the global fingerprint index 926.

Finally, based on identifying the targeted content in the new media file using the set of global fingerprints, systems then refrain from transmitting and/or displaying the identified targeted content of the segment or a selected sub-portion of the segment that is determined to contain the fingerprint-matching targeted content. In this manner, the systems can refrain from displaying the targeted content on a user display (act 915), thereby improving the user experience with the media player. Alternatively, if a segment does not comprise any targeted content, as shown in FIG. 10, the system will transmit the segment (e.g., segment 1004A) to a streaming service (e.g., streaming service 1008) to be displayed on the user's device (e.g., display 1010).

Attention will now be directed to FIG. 9B, which illustrates an example embodiment of a process flowchart for generating a global fingerprint index. In some instances, as shown in FIG. 9B, systems generate a set of fingerprints for each media file (e.g., fingerprints 902 corresponding to media file 902, fingerprints 916 corresponding to media file 910, and fingerprints 924 corresponding to media file 918), which are then aggregated into a global fingerprint index 926.

Attention will now be directed to FIG. 9C, which illustrates an example embodiment of a global fingerprint index. In some instances, a global fingerprint index 926 is utilized to identify targeted content in the media file. For example, the global fingerprint index 926 includes audio fingerprints 928, image fingerprints 930, and/or video fingerprints 932. Some sample categories of targeted content include language 934, violence 936, or other tag/filter 938. The category for language 934 may include one or more words (e.g., Word A) associated with one or more fingerprints (e.g., fingerprint 937, fingerprint 939, fingerprint 941, etc.) that represent Word A or one or more phrases (e.g., Phrase A) associated with one or more fingerprints (e.g., fingerprint 942, fingerprint 944, fingerprint 946, etc.) that represent Phrase A.

The category for violence 936 may include one or more acts (e.g., Act A, Act B, etc.) associated with one or more fingerprints (e.g., fingerprint 948, fingerprint 950, fingerprint 952, etc. for Act A; fingerprint 954, fingerprint 956, fingerprint 958, etc. for Act B). Additional categories for other tags and filters may comprise a plurality of different sub tags and associated fingerprints. For example, Sub Tag A is associated with fingerprint 960, fingerprint 962, fingerprint 964, etc., and Sub Tag B is associated with fingerprint 966, fingerprint 968, fingerprint 970, etc. The fingerprints associated with the tag/filter or sub tag can include audio, image, and/or video fingerprints that are used to facilitate the identification of content in the media file prior that corresponds to the tag/filter or sub tag.

Attention will now be directed to FIG. 9D, which illustrates another example embodiment of a process flowchart for generating a global fingerprint configured as a composite fingerprint. In such instances, the system clusters together all available fingerprints (e.g., fingerprint 937, fingerprint 939, fingerprint 941) that are associated with a particular sub tag (e.g., Word A) under a category of targeted content (e.g., language 934). It should be appreciated that each fingerprint included in association with “Word A” is a variation of the Word A spoken by different speakers in different media content. The fingerprints, even though they represent the same word, could include variations in tone, speed, context, pitch, cadence, prosody, etc. Context information can also be considered and used in building the global composite fingerprint.

The system generates a composite fingerprint 943 based on the plurality of clustered fingerprints, wherein the composite fingerprint 943 is now representative of Word A. However, unlike fingerprint 937, fingerprint 939, and fingerprint 941, which are media-file specific (and speaker/context-specific), composite fingerprint 943 is media-file independent and speaker-independent, meaning that it is able to be used by the system to recognize any media file data the comprise “Word A” as spoken by any number of characters, actors, while still being able to recognize subtleties in context of the word being spoken. This is important because in some contexts, “Word A” may be offensive, while in other contexts, “Word A” is not offensive, and corresponding media file segments do not need to be filtered out during playback.

Attention will now be directed to FIG. 9E, which illustrates another example embodiment of a process flowchart for generating a global fingerprint. In this example, the system identifies one or more fingerprints (e.g., fingerprint 937, fingerprint 939, and fingerprint 941) associated with Word A. The system then uses machine learning model 980 to generate the composite fingerprint 941. Machine learning model 980 is configured to identify and combine relevant attributes from each of the different fingerprints to generate a composite fingerprint that can be used in different settings/media files to identify Word A as targeted content.

In some instances, instead of generating a composite fingerprint as a global fingerprint, systems identify a particular data structure of targeted content from the set of data structures of targeted content and generate a unique fingerprint that represents the particular data structure based on intrinsic attributes of the particular data structure. Systems then convert the unique fingerprint to a global fingerprint that represents the targeted content included in the particular data structure, such that the global fingerprint can be used to identify the targeted content in any data structure.

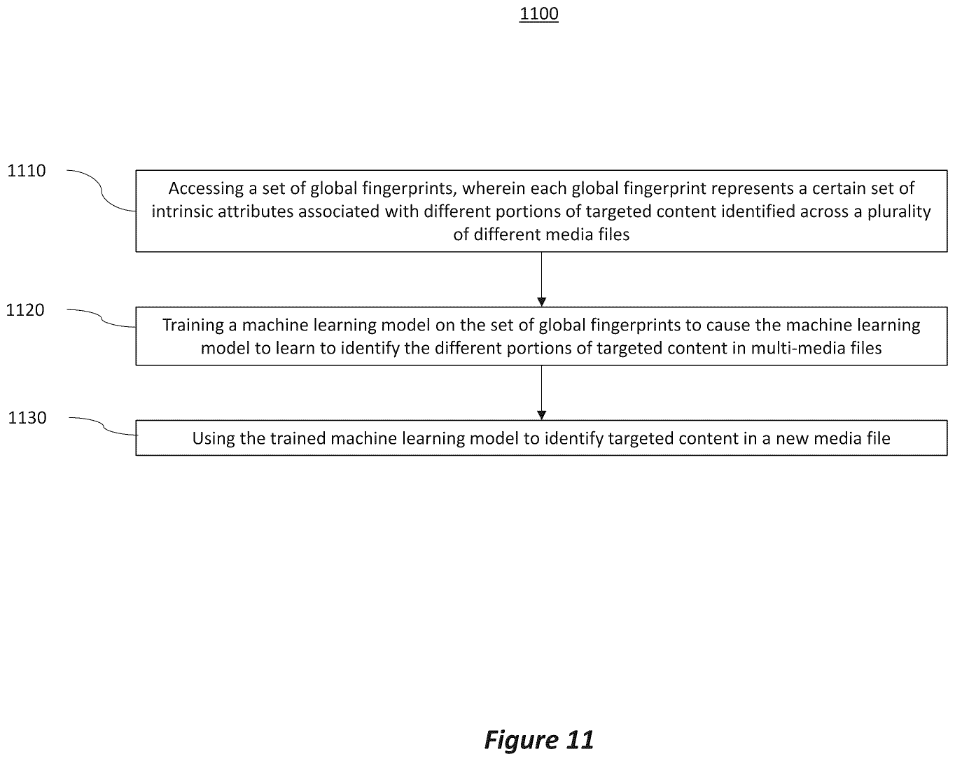

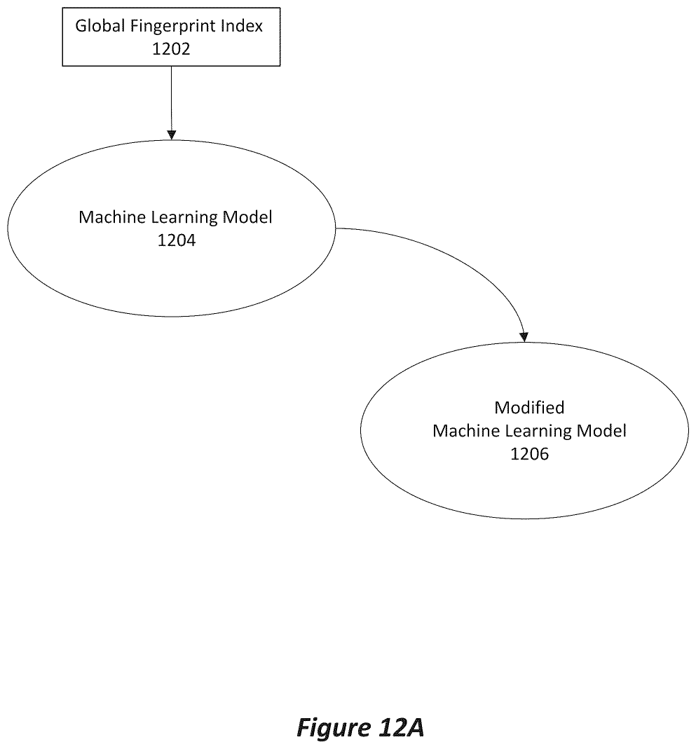

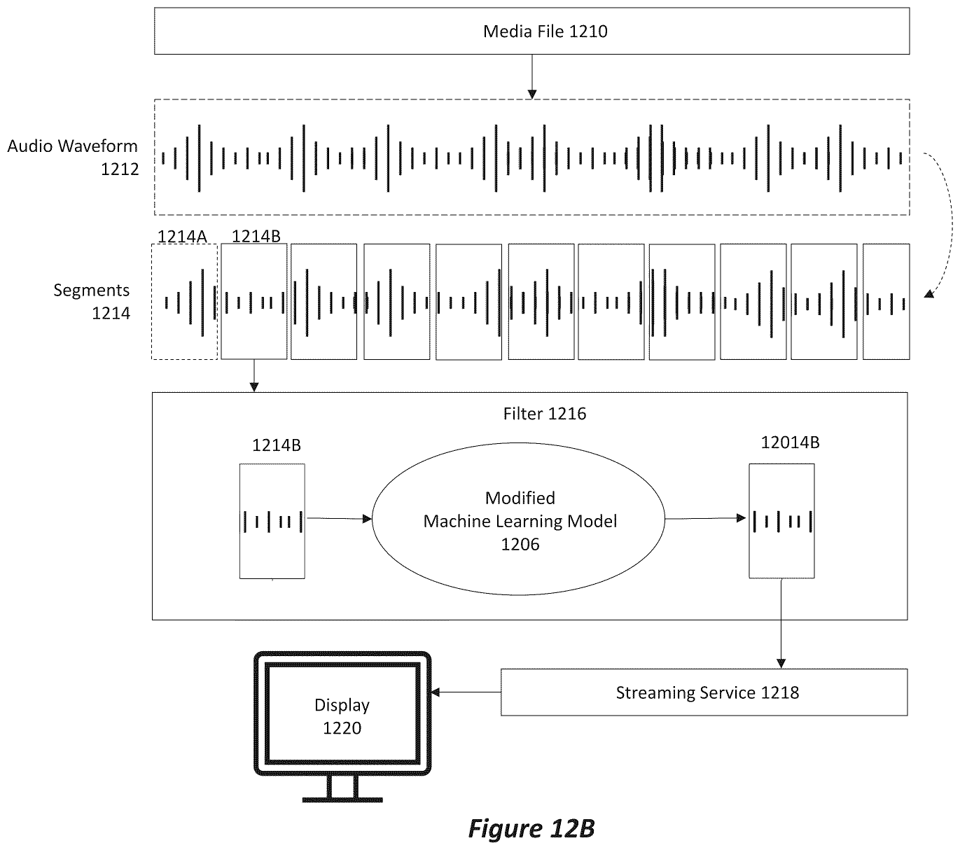

Attention will now be directed to FIG. 11, which illustrates a flowchart of acts (act 1110, act 1120, and act 1130) associated with method 1100 that can be implemented by a computing system (e.g., computing system 1300) and is configured for training a machine learning model on a global fingerprint index to perform improved identification and filtering of targeted content. The acts of FIG. 11 will be described with reference to FIGS. 12A-12B.

A first illustrated act is provided for accessing a set of global fingerprints (e.g., global fingerprint index 1202, representative of any global fingerprint index described herein) (act 1110). Each global fingerprint represents a certain set of intrinsic attributes associated with different portions of targeted content identified across a plurality of different media files.

The global fingerprints are then used as training data to train a machine learning model (e.g., machine learning model 1204) on the set of global fingerprints to cause the machine learning model to learn to identify the different portions of targeted content in multimedia files (act 1120).

Subsequently, systems are configured to use the trained machine learning model (e.g., modified machine learning model 1206) to identify targeted content in a new media file (act 1130). In some instances, this machine learning model is used to identify targeted content (e.g., identify targeted content 406 in FIG. 4A) in data representations to facilitate the process of generating fingerprints for a media, or for generating a composite fingerprint as described in FIG. 9E. Additionally, or alternatively, as shown in FIG. 12B, the trained machine learning model is used to determine which media file segments are transmitted to the media file player to be displayed as part of the media file playback.

Attention will now be directed to FIG. 12B, which illustrates an example embodiment of a process flowchart for implementing a machine learning model previously trained on a global fingerprint index. As shown in FIG. 12B, the systems receive a request from a user to access (e.g., stream or playback) media file 1210. The system generates a plurality of segments 1214 from the media file 1210 or, in some instances, from audio waveform data 1212 extracted from media file 1210.

The system then passes each media file segment sequentially to filter 1216, which has been configured based on one or more different filtering criteria described previously. This filtering criteria is used to set the configuration of the modified machine learning model 1206 to determine which media file segments will be transmitted to the user interface. As shown in FIG. 12B, the system (having previously processed segment 1214A) now feeds segment 1214B to filter 1216. Segment 1214B is provided as input to modified machine learning model 1206, wherein the model determines if 1214B comprises any targeted content that the user does not wish to see based on filtering criteria set by the user. In this case, the model did not detect any targeted content in segment 1214B. Thus, segment 1214B is transmitted to the streaming service 1218 to be displayed as part of the customized user playback experience on display 1220.

In some instances, method 1100 further comprises an act for modifying the machine learning model on the set of global fingerprints to cause the machine learning model to learn to generate new global fingerprints based on user prompts and/or new samples of targeted content. Subsequently, an additional act may be provided for using the modified machine learning model to generate new global fingerprints for a new category of targeted content not previously represented in the set of global fingerprints, wherein the modified machine learning model is further trained on a combination of the set of global fingerprints and the new global fingerprints.

In some instances, generative artificial intelligence may be used to augment the training of the machine learning model. For example, systems identify a new category of targeted content not previously represented in the set of global fingerprints and generate a prompt configured to cause a generative machine learning model to generate media content for the new category of targeted content. Systems then provide the prompt to the generative machine learning model and obtain media content for the new category of targeted content from the generative machine learning model based on the prompt. Systems use the modified machine learning model to generate a new global fingerprint for the new category of targeted content and modify the set of global fingerprints with the new global fingerprint.

In some embodiments, the set of global fingerprints is generated by accessing a plurality of media files comprising audio-visual data and generating a plurality of data representations corresponding to the plurality of media files. Each data representation corresponds to a different media file of the plurality of media files and represents intrinsic attributes of audio-visual data included in the plurality of media files. After generating the plurality of data representations, systems identify a set of data structures of targeted content within the plurality of data representations. Systems then generate a plurality of data structure subsets by clustering similar data structures together into different data structure subsets and generating a set of global fingerprints. Each global fingerprint represents a different data structure subset such that a global fingerprint can be used to identify specific target content in a variety of media files.

### Example Computing Systems

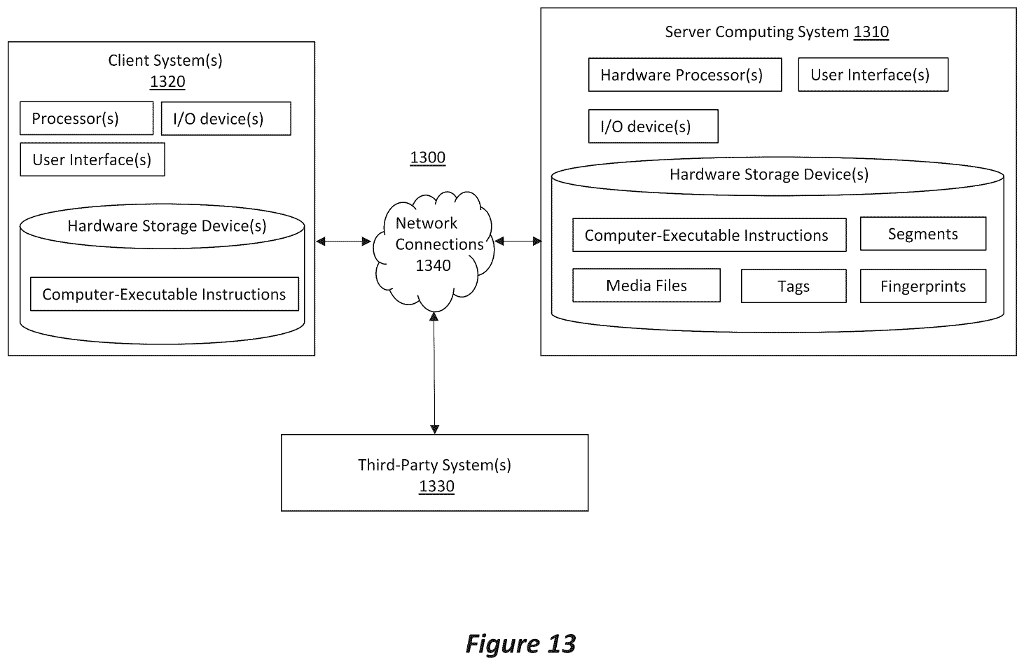

Attention will now be directed to FIG. 13, which illustrates computing environment 1300 that includes client system(s) 1320 and third-party system(s) 1330 in communication (via a network 1340) with computing system 1310. As illustrated, computing system 1310 is a server computing system configured to compile, modify, and implement a neural transducer configured to perform speech recognition on multi-speaker speech data, including overlapping speech from multiple speakers.

The computing system 1310, for example, includes one or more processor(s) (such as one or more hardware processor(s) and one or more hardware storage device(s) storing computer-readable instructions. One or more of the hardware storage device(s) can house any number of data types and any number of computer-executable instructions by which the computing system 1310 is configured to implement one or more aspects of the disclosed embodiments when the computer-executable instructions are executed by the one or more hardware processor(s). The computing system 1310 is also shown including user interface(s) and input/output (I/O) device(s).

As shown in FIG. 13, the hardware storage device(s) is shown as a single storage unit. However, it will be appreciated that the hardware storage device(s) can include a distributed storage that is distributed to several separate and sometimes remote systems and/or third-party system(s). The computing system 1310 can also comprise a distributed system with one or more of the components of computing system 1310 being maintained/run by different discrete systems that are remote from each other and that each discrete system performs different tasks. In some instances, a plurality of distributed systems performs similar and/or shared tasks for implementing the disclosed functionality, such as in a distributed cloud environment.

The computing system is in communication with client system(s) 1320 comprising one or more processor(s), one or more user interface(s), one or more I/O device(s), one or more sets of computer-executable instructions, and one or more hardware storage device(s). In some instances, users of a particular software application (e.g., Microsoft Teams) engage with the software at the client system which transmits the audio data to the server computing system to be processed, wherein the predicted labels are displayed to the user on a user interface at the client system. Alternatively, the server computing system can transmit instructions to the client system for generating and/or downloading a neural transducer model, wherein the processing of the audio data by the model occurs at the client system.

The computing system is also in communication with third-party system(s). It is anticipated that, in some instances, the third-party system(s) 1330 further comprise databases housing data that could be used as training data, for example, text data not included in local storage. Additionally, or alternatively, the third-party system(s) 1330 includes machine learning systems external to the computing system 1310.

It will be appreciated that the disclosed embodiments may include, be practiced by, or implemented by a computer system (e.g., computing system 1310) that is configured with computer storage that stores computer-executable instructions that, when executed by one or more processing systems (e.g., one or more hardware processors) of the computer system, cause various functions to be performed, such as the acts associated with the various methods recited above.

Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions are physical storage media. Computer-readable media that carry computer-executable instructions are transmission media. Thus, by way of example, embodiments of the disclosure can comprise at least two distinctly different kinds of computer-readable media: physical computer-readable storage media and transmission computer-readable media.

Physical computer-readable storage media includes random access memory (RAM), read-only memory (ROM), electrically erasable programmable ROM (EEPROM), compact disk ROM (CD-ROM), or other optical disk storage (such as compact disks (CDs), digital video disks (DVDs), etc.), magnetic disk storage or other magnetic storage devices, or any other hardware storage devices which can be used to store desired program code in the form of computer-executable instructions or data structures and which can be accessed by a general purpose or special purpose computer.

When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above are also included within the scope of computer-readable media.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a network interface card (NIC)), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may exist in both local and remote memory storage devices.

Alternatively, or in addition, the functionality described herein can be performed, at least in part, by one or more hardware logic components. For example, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In view of the foregoing, the disclosed embodiments beneficially provide systems and methods for providing an improved identifying, tagging, and filtering process for targeted content in media files. For example, in some embodiments, systems, and methods are provided for generating and using media-file-specific fingerprints to identify and filter targeted content in a particular media file. Additionally, or alternatively, some systems and methods are provided for generating and using global fingerprints to identify and filter targeted content in different media files. Some embodiments are also directed to systems and methods that utilize a machine learning model trained on global fingerprints to facilitate an efficient and accurate identification, tagging, and filtering process.

Such systems and methods realize many benefits over time-based tagging systems and methods, wherein the novel systems and methods described herein relate to intrinsic attribute-based tagging systems that can be used on many different media files, no matter the source. Additionally, these intrinsic attribute tags are configurable to be increased in scope to different media files comprising different media content across multiple sources and platforms. In other words, while time-based tags are limited to use for a particular movie (and suffer degradation in utility/accuracy for identifying targeted content in the same movie but obtained from/played back through a different source), these intrinsic attribute tags are applicable to the same movie across all platforms/sources without incurring a decrease in accuracy for identifying/filtering targeted content. Additionally, these intrinsic attribute tags are also applicable globally to different movies, television shows, podcasts, or other media content.

### Clauses

In view of the foregoing description, it will be appreciated that the present invention can also be described in accordance with the following numbered clauses:

Clause 1. A method for generating a set of fingerprints for filtering out targeted content in a media file, the method comprising: accessing a media file; generating a data representation of the media file that represents intrinsic attributes of the media file; identifying one or more data structures of targeted content in the data representation, each data structure being associated with a unique set of intrinsic attributes; receiving a request to stream the media file; generating a plurality of segments of the media file to be transmitted to a media player for sequential playback; comparing each segment of the plurality of segments against a set of fingerprints generated for the targeted content, based on the unique set of intrinsic attributes for the particular data structures corresponding to the one or more data structures of the targeted content; and upon determining that a particular segment or portion of a segment matches one or more fingerprints included in the set of fingerprints, refraining from transmitting the particular segment or portion of the segment that matches the one or more fingerprints to the media player, such that the sequential playback of the plurality of segments does not comprise any targeted content.

Clause 2. The method of clause 1, wherein the data representation comprises one or more of a following: audio waveform data, spectrogram data, image data, or video data.

Clause 3. The method of clause 1, further comprising: subsequent to generating the set of fingerprints, receiving user input that defines one or more categories of targeted content; and filtering the set of fingerprints to include only those fingerprints that correspond to the one or more categories of targeted content, such that the sequential playback of the plurality of segments does not comprise targeted content from the one or more categories.

Clause 4. The method of clause 1, further comprising: prior to generating the set of fingerprints, receiving user input that defines one or more categories of targeted content; identifying one or more data structures of targeted content that correspond to the one or more categories of targeted content; generating a customized set of fingerprints of the one or more data structures of targeted content that correspond to the one or more categories of targeted content; and using the customized set of fingerprints to determine which segments of the plurality of segments or portions of the segments will be transmitted to the media player.

Clause 5. The method of clause 1, wherein the media file comprises one or more of: audio data, visual data, or audio-visual data.

Clause 6. The method of clause 1, further comprising: receiving a request to stream a new media file that corresponds to the media file in content but is associated with a different source; generating a plurality of new segments of the new media file to be transmitted to the media player for sequential playback; comparing each new segment of the plurality of new segments against the set of fingerprints; and upon determining that a portion of a particular new segment matches one or more fingerprints included in the set of fingerprints, refraining from transmitting the portion of the particular new segment to the media player, such that the sequential playback of the plurality of segments does not comprise any targeted content.

Clause 7. The method of clause 1, further comprising: identifying a fingerprint match threshold that represents minimum confidence score that must be met to determine that a segment or a portion of a segment matches a fingerprint for purposes of filtering; subsequent to comparing each segment of the plurality of segments against the set of fingerprints, determining that a particular segment or a portion of the particular segment at least meets the fingerprint match threshold; and upon determining that the particular segment or portion of the particular segment at least meets the fingerprint match threshold, refraining from transmitting the particular segment or portion of the particular segment to the media player.

Clause 8. A method for generating a set of global fingerprints for filtering out targeted content in a media file, the method comprising: accessing a plurality of media files comprising audio-visual data; generating a plurality of data representations corresponding to the plurality of media files, wherein each data representation corresponds to a different media file of the plurality of media files and represents intrinsic attributes of audio-visual data included in the plurality of media files; identifying a set of data structures of targeted content within the plurality of data representations; generating a plurality of data structure subsets by clustering similar data structures together into different data structure subsets; generating a set of global fingerprints, wherein each global fingerprint represents a different data structure subset such that a global fingerprint can be used to identify specific target content in a variety of media files; accessing a new media file not previously included in the plurality of media files; using the set of global fingerprints to identify targeted content in the new media file; and refraining from displaying the identified targeted content on a user display.

Clause 9. The method of claim 8, further comprising: generating a composite data structure for each data structure subset, such that each global fingerprint corresponds to a different composite data structure.

Clause 10. The method of claim 8, wherein the plurality of media files comprises one or more of: audio data, image data, or video data.

Clause 11. The method of claim 8, wherein the plurality of data representations comprises one or more of: audio waveform data, spectrogram data, image data, or video data.

Clause 12. The method of claim 8, further comprising: receiving a request to stream the new media file; generating a plurality of segments of the new media file to be transmitted to a media player for sequential playback; comparing each segment of the plurality of segments against the set of global fingerprints; and upon determining that a particular segment matches one or more global fingerprints included in the set of global fingerprints, refraining from transmitting the particular segment to the media player, such that the sequential playback of the plurality of segments of the new media file does not comprise any targeted content.

Clause 13. The method of claim 8, further comprising: identifying a particular data structure of targeted content from the set of data structures of targeted content; generating a unique fingerprint that represents the particular data structure based on intrinsic attributes of the particular data structure; and converting the unique fingerprint to a global fingerprint that represents the targeted content included in the particular data structure, such that the global fingerprint can be used to identify the targeted content in any data structure.

Clause 14. A method for training a machine learning model to perform improved identification and filtering of targeted content in multimedia files, the method comprising: accessing a set of global fingerprints, wherein each global fingerprint represents a certain set of intrinsic attributes associated with different portions of targeted content identified across a plurality of different media files; training a machine learning model on the set of global fingerprints to cause the machine learning model to learn to identify the different portions of targeted content in multimedia files; and using the trained machine learning model to identify targeted content in a new media file.

Clause 15. The method of claim 14, further comprising: modifying the machine learning model on the set of global fingerprints to cause the machine learning model to learn to generate new global fingerprints based on user prompts and/or new samples of targeted content.

Clause 16. The method of claim 15, further comprising: using the modified machine learning model to generate new global fingerprints for a new category of targeted content not previously represented in the set of global fingerprints; and further training the modified machine learning model on a combination of the set of global fingerprints and the new global fingerprints.

Clause 17. The method of claim 15, further comprising: identifying a new category of targeted content not previously represented in the set of global fingerprints; generating a prompt configured to cause a generative machine learning model to generate media content for the new category of targeted content; providing the prompt the generative machine learning model; obtaining media content for the new category of targeted content from the generative machine learning model based on the prompt; using the modified machine learning model to generate a new global fingerprint for the new category of targeted content; and modifying the set of global fingerprints with the new global fingerprint.

Clause 18. The method of claim 14, wherein the plurality of different media files comprises one or more of: audio data, image data, or video data.

Clause 19. The method of claim 14, wherein the set of global fingerprints is generated by: accessing a plurality of media files comprising audio-visual data; generating a plurality of data representations corresponding to the plurality of media files, wherein each data representation corresponds to a different media file of the plurality of media files and represents intrinsic attributes of audio-visual data included in the plurality of media files; identifying a set of data structures of targeted content within the plurality of data representations; generating a plurality of data structure subsets by clustering similar data structures together into different data structure subsets; and generating a set of global fingerprints, wherein each global fingerprint represents a different data structure subset such that a global fingerprint can be used to identify specific target content in a variety of media files.

Clause 20. The method of claim 19, wherein the plurality of data representations comprises one or more of: audio waveform data, spectrogram data, image data, or video data.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed:

1. A method for generating a set of fingerprints for filtering out targeted content in a media file, the method comprising:
accessing a media file;
generating a data representation of the media file that represents intrinsic attributes of the media file;
identifying one or more data structures of targeted content in the data representation, each data structure being associated with a unique set of intrinsic attributes;
receiving a request to stream the media file;
generating a plurality of segments of the media file to be transmitted to a media player for sequential playback;
comparing each segment of the plurality of segments against a set of fingerprints generated for the targeted content, based on the unique set of intrinsic attributes for the particular data structures corresponding to the one or more data structures of the targeted content; and
upon determining that a particular segment or portion of a segment matches one or more fingerprints included in the set of fingerprints, refraining from transmitting the particular segment or portion of the segment that matches the one or more fingerprints to the media player, such that the sequential playback of the plurality of segments does not comprise any targeted content.

2. The method of claim 1, wherein the data representation comprises one or more of a following: audio waveform data, spectrogram data, image data, or video data.

3. The method of claim 1, further comprising:
subsequent to generating the set of fingerprints, receiving user input that defines one or more categories of targeted content; and
filtering the set of fingerprints to include only those fingerprints that correspond to the one or more categories of targeted content, such that the sequential playback of the plurality of segments does not comprise targeted content from the one or more categories.

4. The method of claim 1, further comprising:
prior to generating the set of fingerprints, receiving user input that defines one or more categories of targeted content;
identifying one or more data structures of targeted content that correspond to the one or more categories of targeted content;
generating a customized set of fingerprints of the one or more data structures of targeted content that correspond to the one or more categories of targeted content; and
using the customized set of fingerprints to determine which segments of the plurality of segments or portions of the segments will be transmitted to the media player.

5. The method of claim 1, wherein the media file comprises one or more of: audio data, visual data, or audio-visual data.

6. The method of claim 1, further comprising:
receiving a request to stream a new media file that corresponds to the media file in content but is associated with a different source;
generating a plurality of new segments of the new media file to be transmitted to the media player for sequential playback;
comparing each new segment of the plurality of new segments against the set of fingerprints; and
upon determining that a portion of a particular new segment matches one or more fingerprints included in the set of fingerprints, refraining from transmitting the portion of the particular new segment to the media player, such that the sequential playback of the plurality of segments does not comprise any targeted content.

7. The method of claim 1, further comprising:
identifying a fingerprint match threshold that represents minimum confidence score that must be met to determine that a segment or a portion of a segment matches a fingerprint for purposes of filtering;
subsequent to comparing each segment of the plurality of segments against the set of fingerprints, determining that a particular segment or a portion of the particular segment at least meets the fingerprint match threshold; and
upon determining that the particular segment or portion of the particular segment at least meets the fingerprint match threshold, refraining from transmitting the particular segment or portion of the particular segment to the media player.

8. A method for generating a set of global fingerprints for filtering out targeted content in a media file, the method comprising:
accessing a plurality of media files comprising audio-visual data;
generating a plurality of data representations corresponding to the plurality of media files, wherein each data representation corresponds to a different media file of the plurality of media files and represents intrinsic attributes of audio-visual data included in the plurality of media files;
identifying a set of data structures of targeted content within the plurality of data representations;
generating a plurality of data structure subsets by clustering similar data structures together into different data structure subsets;
generating a set of global fingerprints, wherein each global fingerprint represents a different data structure subset such that a global fingerprint can be used to identify specific target content in a variety of media files;
accessing a new media file not previously included in the plurality of media files;
using the set of global fingerprints to identify targeted content in the new media file; and
refraining from displaying the identified targeted content on a user display.

9. The method of claim 8, further comprising:
generating a composite data structure for each data structure subset, such that each global fingerprint corresponds to a different composite data structure.

10. The method of claim 8, wherein the plurality of media files comprises one or more of: audio data, image data, or video data.

11. The method of claim 8, wherein the plurality of data representations comprises one or more of: audio waveform data, spectrogram data, image data, or video data.

12. The method of claim 8, further comprising:
receiving a request to stream the new media file;
generating a plurality of segments of the new media file to be transmitted to a media player for sequential playback;
comparing each segment of the plurality of segments against the set of global fingerprints; and
upon determining that a particular segment matches one or more global fingerprints included in the set of global fingerprints, refraining from transmitting the particular segment to the media player, such that the sequential playback of the plurality of segments of the new media file does not comprise any targeted content.

13. The method of claim 8, further comprising:
identifying a particular data structure of targeted content from the set of data structures of targeted content;
generating a unique fingerprint that represents the particular data structure based on intrinsic attributes of the particular data structure; and
converting the unique fingerprint to a global fingerprint that represents the targeted content included in the particular data structure, such that the global fingerprint can be used to identify the targeted content in any data structure.

14. A method for training a machine learning model to perform improved identification and filtering of targeted content in multimedia files, the method comprising:
accessing a set of global fingerprints, wherein each global fingerprint represents a certain set of intrinsic attributes associated with different portions of targeted content identified across a plurality of different media files;
training a machine learning model on the set of global fingerprints to cause the machine learning model to learn to identify the different portions of targeted content in multimedia files; and
using the trained machine learning model to identify targeted content in a new media file.

15. The method of claim 14, further comprising:
modifying the machine learning model on the set of global fingerprints to cause the machine learning model to learn to generate new global fingerprints based on user prompts and/or new samples of targeted content.

16. The method of claim 15, further comprising:
using the modified machine learning model to generate new global fingerprints for a new category of targeted content not previously represented in the set of global fingerprints; and
further training the modified machine learning model on a combination of the set of global fingerprints and the new global fingerprints.

17. The method of claim 15, further comprising:
identifying a new category of targeted content not previously represented in the set of global fingerprints;
generating a prompt configured to cause a generative machine learning model to generate media content for the new category of targeted content;
providing the prompt to the generative machine learning model;
obtaining media content for the new category of targeted content from the generative machine learning model based on the prompt;
using the modified machine learning model to generate a new global fingerprint for the new category of targeted content; and
modifying the set of global fingerprints with the new global fingerprint.

18. The method of claim 14, wherein the plurality of different media files comprises one or more of: audio data, image data, or video data.

19. The method of claim 14, wherein the set of global fingerprints is generated by:
accessing a plurality of media files comprising audio-visual data;
generating a plurality of data representations corresponding to the plurality of media files, wherein each data representation corresponds to a different media file of the plurality of media files and represents intrinsic attributes of audio-visual data included in the plurality of media files;
identifying a set of data structures of targeted content within the plurality of data representations;
generating a plurality of data structure subsets by clustering similar data structures together into different data structure subsets; and
generating a set of global fingerprints, wherein each global fingerprint represents a different data structure subset such that a global fingerprint can be used to identify specific target content in a variety of media files.

20. The method of claim 19, wherein the plurality of data representations comprises one or more of: audio waveform data, spectrogram data, image data, or video data.
